(19) United States
(12) Patent Application Publication
(10) Pub. No.: US 2023/0328594 A1
(43) Pub. Date: Oct. 12, 2023

(54) COMMUNICATION DEVICE

(71) Applicant: SONY GROUP CORPORATION, TOKYO (JP)

(72) Inventors: KEN TANAKA, TOKYO (JP); KOSUKE AIO, KANAGAWA (JP); HIROMASA UCHIYAMA, TOKYO (JP)

(21) Appl. No.: 18/044,205

(22) PCT Filed: Aug. 31, 2021
(86) PCT No.: PCT/JP2021/031816

§ 371 Date: Mar. 6, 2023

(30) Foreign Application Priority Data
Sep. 14, 2020 (JP) 2020-154175

(51) Int. Cl. H04W 28/16; H04B 7/08

(52) U.S. Cl. CPC H04W 28/16; H04B 7/0848

(57) ABSTRACT

The present technology relates to a communication device enabling improvement of communication quality. A communication device includes a control unit configured to, in performing joint reception with a first communication device on a reception signal from one or more second communication devices, perform control of: generating first information indicating likelihood information of the reception signal for every second communication device; generating second information regarding an information amount of the first information that can be stored in a storage unit configured to temporarily store the likelihood information; and transmitting the first information and the second information to the first communication device. The present technology can be applied to, for example, a device constituting a wireless LAN system.

### TECHNICAL FIELD

The present technology relates to a communication device, and particularly to a communication device capable of improving communication quality.

### BACKGROUND ART

In recent years, with the spread of wireless local area network (LAN) systems, various technologies related to coordination between access points (APs) have been proposed. As this type of technology, there is a joint communication scheme in which a plurality of access points jointly executes communication (see, for example, Non Patent Document 1). A plurality of access points for joint operation is referred to as a Multi AP.

### CITATION LIST

### Non Patent Document

Non Patent Document 1: Roya Doostnejad, et al., “Uplink Coordinated Multi-AP,” IEEE 802.11-19/1903r0 2019

### SUMMARY OF THE INVENTION

### Problems to be Solved by the Invention

In a case where a plurality of access points jointly executes communication, improvement in communication quality is required. The present technology has been made in view of such a situation, and is intended to enable improvement of communication quality.

### Solutions to Problems

A communication device according to one aspect of the present technology is a communication device including a control unit configured to, in performing joint reception with a first communication device on a reception signal from one or more second communication device, perform control of: generating first information indicating likelihood information of the reception signal for each of the one or more second communication devices; generating second information regarding an information amount of the first information that can be stored in a storage unit configured to temporarily store the likelihood information; and transmitting the first information and the second information to the first communication device.

In the communication device according to one aspect of the present technology, in performing joint reception with the first communication device on a reception signal from the one or more second communication devices, first information is generated indicating likelihood information of the reception signal for each of the one or more second communication devices, second information is generated regarding an information amount of the first information that can be stored in the storage unit configured to temporarily store the likelihood information, and the first information and the second information are transmitted to the first communication device.

A communication device according to one aspect of the present technology is a communication device including a control unit configured to, in performing joint reception with a first communication device on a reception signal from one or more second communication devices, perform control of generating ninth information including: information indicating a request for the joint reception to the first communication device; information indicating a notification request for an information amount of first information that can be stored in a storage unit of the first communication device in the joint reception; and information indicating a request scheme related to a calculation scheme of a log-likelihood ratio in the first communication device, and the control unit is configured to transmit the ninth information to the first communication device.

In the communication device according to one aspect of the present technology, in performing joint reception with the first communication device on a reception signal from the one or more second communication devices, ninth information is generated including: information indicating a request for the joint reception to the first communication device; information indicating a notification request for an information amount of first information that can be stored in the storage unit of the first communication device in the joint reception; and information indicating a request scheme related to a calculation scheme of a log-likelihood ratio in the first communication device, and the ninth information is transmitted to the first communication device.

A communication device according to one aspect of the present technology is a communication device that is a second communication device, the communication device including a control unit configured to perform control of: generating twelfth information indicating that joint reception is requested to, as a destination, a plurality of first communication devices that operates jointly with each other in transmitting a transmission signal; and transmitting the twelfth information to the first communication devices.

In the communication device according to one aspect of the present technology, the communication device is the second communication device, twelfth information is generated indicating that joint reception is requested to, as a destination, a plurality of first communication devices that operates jointly with each other in transmitting a transmission signal, and the twelfth information is transmitted to the first communication devices.

Note that the communication device according to one aspect of the present technology may be an independent device or an internal block constituting one device.

### BRIEF DESCRIPTION OF DRAWINGS

FIG. 1 is a view illustrating a configuration example of a wireless network system to which the present technology is applied.

FIG. 2 is a diagram illustrating a configuration example of an embodiment of a communication device to which the present technology is applied.

FIG. 3 is a view illustrating a first example of an entire sequence of the present technology.

FIG. 4 is a view illustrating a configuration example of a frame whose notification is provided in Capabilities Exchange.

FIG. 5 is a view illustrating a configuration example of a frame whose notification is provided in LLR Combining Setup Request.

FIG. 6 is a view illustrating a configuration example of a frame whose notification is provided in LLR Combining Setup Response.

FIG. 7 is a view illustrating a configuration example of a frame whose notification is provided in LC Trigger.

FIG. 8 is a view illustrating a configuration example of a data unit transmitted in UL Transmission.

FIG. 9 is a view illustrating another configuration example of a data unit transmitted in UL Transmission.

FIG. 10 is a view illustrating a configuration example of a frame whose notification is provided in LLR Report Trigger.

FIG. 11 is a view illustrating a configuration example of a frame whose notification is provided in LLR Report.

FIG. 12 is a view illustrating a second example of an entire sequence of the present technology.

FIG. 13 is a view illustrating a configuration example of a frame whose notification is provided in LLR Combining Setup Request.

FIG. 14 is a view illustrating a configuration example of a frame whose notification is provided in LC Trigger.

FIG. 15 is a view illustrating a third example of an entire sequence of the present technology.

FIG. 16 is a view illustrating a configuration example of a frame whose notification is provided in LC Announcement.

FIG. 17 is a view illustrating a configuration example of a data unit whose notification is provided in LC Trigger.

### MODE FOR CARRYING OUT THE INVENTION

### 1. First Embodiment

In a wireless local area network (LAN), in one basic service set (BSS), an access point (an access point (AP) or a base station (BS)) and a user terminal (a station (STA) or user equipment (UE)) autonomously acquire a transmission right in the BSS and perform communication.

In a case where a plurality of antennas is mounted on a communication terminal, in transmission (multiple input multiple output (MIMO)) using the plurality of antennas simultaneously, formation of directivity in a desired direction (hereinafter, referred to as beamforming (BF)) can be realized by multiplying a transmission antenna and a reception antenna by appropriate weights. As a result, it is possible to improve a transmission gain of a transmitting terminal to a desired destination terminal, and improve a transmission gain of a receiving terminal from a desired terminal.

The transmission gain can be further improved when a plurality of APs (hereinafter, referred to as a Multi AP) that jointly operates with each other performs joint reception (JR) on a signal from a common transmitting user terminal, by extending the BF described above. While there may be a plurality of joint schemes in JR, a highest peak rate can be achieved ideally, in particular, in a scheme (hereinafter, referred to as coherent joint reception (CJR)) of weighting and combining complex reception signals such that the multi AP operates as one virtual AP, among the joint schemes. However, there are problems such as characteristic degradation due to a frequency synchronization error between APs, and a decrease in an effective rate due to a high transmission rate request when received data is shared between APs.

As another joint scheme in JR, a method (hereinafter, referred to as LLR Combining) is considered in which, in a case where a signal common to individual APs is transmitted from the STA, a log-likelihood ratio (LLR) for bits of a reception signal observed in each AP is calculated, and the calculated log-likelihood ratios are combined. In LLR Combining, a format of data shared between the individual APs may simply be the log-likelihood ratio. Therefore, although the peak rate is low, the data format shared between APs may simply be the log-likelihood ratio, an amount of data shared between APs is smaller than that of CJR, requested frequency synchronization accuracy is coarse as compared to CJR, so that a high effective rate can be expected.

IEEE 802.11 defines communication schemes for a case of transmission from one STA to one AP (single user MIMO (SU MIMO)) and a case of simultaneous transmission from a plurality of STAs to one AP (multi user MIMO (MU MIMO)), in transmission links (hereinafter, referred to as an uplink) to AP from STA each having a plurality of antennas. In any of the schemes, a log-likelihood ratio of transmitted data is calculated for every STA, and data bits are demodulated by performing error correction such as low-density parity check (LDPC) code. Here, as an example of obtaining the log-likelihood ratio, the log-likelihood ratio can be calculated as the following Equation (1).

$$[ Formula 1 ]$$

$${λ}_{( k , n )} = {\sum }_{{x}_{i} ∈ {X}_{1}^{( n )}}^{\cdot } \frac{{\vert {y}_{( k )} - {x}_{i} \vert}^{2}}{{γ}^{2}} - {\sum }_{{x}_{j} ∈ {X}_{0}^{( n )}}^{\cdot } \frac{{\vert {y}_{( k )} - {x}_{j} \vert}^{2}}{{γ}^{2}} \qquad ( 1 )$$

However, in Equation (1), λ(k, n) represents a log-likelihood ratio of an n-th bit in a k-th complex symbol of a reception signal, and the k-th complex symbol is represented as y(k) with respect to a reception signal subjected to channel equalization. Furthermore, X((n);1) and X((n);0) represent complex symbol point candidates of a transmission signal in which the n-th bit each is 1 or 0 with respect to the complex symbol of the reception signal subjected to the channel equalization, and γ represents a signal-to-noise ratio (SNR) of the transmission link.

Note that, here, for convenience of description, when A(b;c) is described, b represents a superscript for A, and c represents a subscript for A, individually. For example, when X((n);1) is described, it means that (n) is superscript and 1 is subscript for X. These relationships are also similarly applied to the description described later.

That is, the log-likelihood ratio of the n-th bit to a complex symbol of a certain reception signal subjected to channel equalization is to be a value obtained by obtaining a ratio between a Euclidean distance to a complex symbol point candidate of a transmission signal whose n-th bit is 1 on a complex plane and a Euclidean distance to a complex symbol point candidate of a transmission signal whose n-th bit is 0 on a complex plane, and normalizing by the SNR of the transmission link.

Error correction processing is executed on the reception side on the basis of the calculated log-likelihood ratio, but the error correction processing is generally executed on a certain group of log-likelihood ratios (CW:codeword). However, from the viewpoint of reducing a computation amount, the distances to the complex symbol point candidates of all the transmission signals may not necessarily be obtained.

In particular, in Document 1 below, it is designed that complex symbols or bits transmitted in the same CW are transmitted on links of the same quality. Although the calculation method of the log-likelihood ratio is implementation dependent, in a case where the log-likelihood ratio is calculated by using this design, γ in Equation (1) does not need to be calculated, and the computation amount can be further reduced. That is, γ may be calculated as a fixed value such as γ=1, and it is not necessary to calculate γ².

Document 1: IEEE 802.11, 2016

Whereas, while it is necessary to notify of a log-likelihood ratio between APs in order to execute LLR Combining in the multi AP, it is necessary to appropriately combine log-likelihood ratios in accordance with link quality between the STA and a plurality of APs constituting the multi AP, in order to execute LLR Combining. That is, in a case where the log-likelihood ratio is calculated in one AP, γ in Equation (1) is not necessary, but the log-likelihood ratio cannot be appropriately combined without γ in Equation (1) in LLR Combining for combining log-likelihood ratios obtained by different APs.

(First Problem: Information Format for Notifying of Log-Likelihood Ratio)

Document 2 below mentions that, as LLR Combining executed by coordination between a plurality of base stations (coordinated multi-point transmission and reception: CoMP) of a remote radio head (RRH) in a cellular network, log-likelihood ratios calculated by the RRH are aggregated into a baseband unit (BBU) and combined. Furthermore, although the log-likelihood ratio calculated in each RRH is shown in Equation 5 in Document 2, weighting is performed according to the SNR of each RRH as in Equation (1) described above, but an information format of the log-likelihood ratio to be transformed is not mentioned.

Document 2: Kenji Miyamoto, et al., “Unified Design of LLR Quantization and Joint Reception for Mobile Fronthaul Bandwidth Reduction,” IEEE VTC-Spring 2017, June 2017

(Second Problem: Notification of Information Amount of Log-Likelihood Ratio that can be Stored in Each AP)

Furthermore, in LLR Combining, a terminal that aggregates and combines log-likelihood ratios and a terminal that notifies of the log-likelihood ratio need to temporarily store the log-likelihood ratios calculated by the self. In particular, IEEE 802.11 specifies that error correction processing is executed for every CW after calculation of the log-likelihood ratio, and does not provide a signal processing flow for executing LLR Combining.

For this reason, in the terminal that aggregates the log-likelihood ratios in advance and the terminal that notifies of the log-likelihood ratio in advance prior to execution of LLR Combining, it is necessary to mutually know an information amount of the log-likelihood ratio that can be temporarily stored. This is because LLR Combining can be executed only for a log-likelihood ratio of a minimum information amount at most among the information amounts of both.

As related to the description above, Document 1 described above defines a buffer status report (BSRP), but this merely notifies of a traffic amount with high priority held in a queue by the terminal, and is different from that indicating an information amount that can be temporarily stored.

(Third Problem: Relationship Between Resolution of Log-Likelihood Ratio and Effective Rate)

Furthermore, the log-likelihood ratios to be notified between APs have different decoding characteristics of LLR Combining depending on a quantum resolution to be expressed. Communication quality (or the SNR) is different between each AP constituting the Multi AP and the STA. Therefore, in an AP having a relatively low communication quality, decoding characteristics can be improved by combining with a log-likelihood ratio obtained in an AP having a high communication quality. However, in an AP with high communication quality, even if the AP is combined with a log-likelihood ratio obtained in an AP with relatively low communication quality, a gain by LLR Combining can be expected only slightly.

In this case, overhead caused by transmitting the log-likelihood ratio between APs is larger than the gain obtained in LLR Combining, and an effective rate decreases. At this time, it is possible to suppress a decrease in effective rate more by retransmitting a corresponding signal from the STA by transmitting the log-likelihood ratio between the APs.

In Document 3 below, a quantization resolution is controlled by a modulation method, but a station that generates a log-likelihood ratio and a station that executes LLR Combining are independent. In a system to which the present technology is applied, one AP holds a log-likelihood ratio calculated with its own reception signal already received from an STA, and executes LLR Combining. Therefore, by controlling a target range of the log-likelihood ratio to be notified in accordance with the already held log-likelihood ratio or link quality, it is possible to select an optimal scheme from among LLR Combining and retransmission, and it is possible to improve the effective rate.

Document 3: Japanese Patent Application Laid-Open No. 2018-74515

In the present technology, in order to solve the above-described problems, for example, the following solution is implemented in a multi AP that executes LLR Combining.

That is, in order to solve the second problem, “an information amount of a log-likelihood ratio” that can be temporarily stored by each AP is notified prior to execution of LLR Combining. Furthermore, in order to solve the first problem, an appropriate log-likelihood ratio is notified prior to execution of LLR Combining. Furthermore, in order to solve the third problem, a threshold value is designated for determining a resolution of a log-likelihood ratio to be notified prior to execution of LLR Combining or a range of a log-likelihood ratio to be notified.

In the present technology, by implementing these solutions, communication quality can be improved in executing of LLR Combining. Hereinafter, an embodiment of the present technology will be described with reference to the drawings.

(System Configuration)

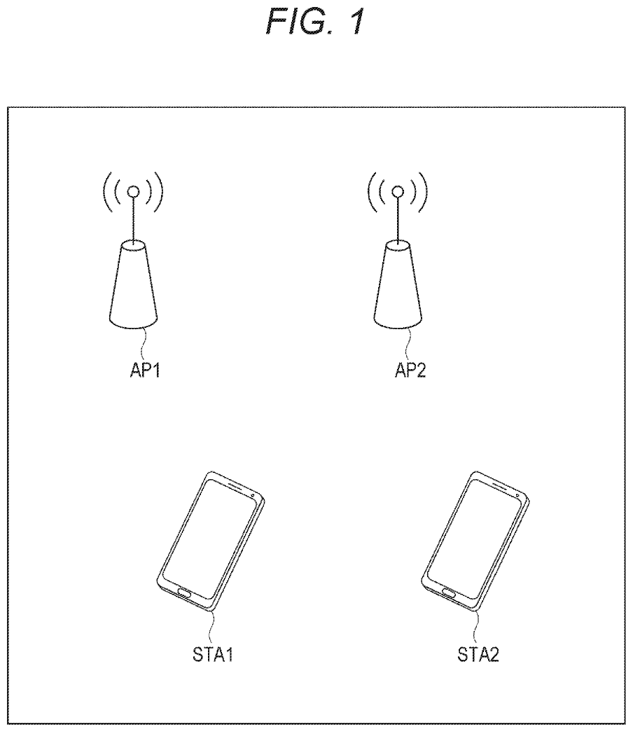

FIG. 1 illustrates a configuration example of a wireless LAN system, as a wireless network system to which the present technology is applied.

In FIG. 1, it is assumed that a plurality of access points AP1 and AP2 (hereinafter, also collectively referred to as a Multi AP) and communication terminals STA1 and STA2 are connected to each other, and LLR Combining is executed in uplink transmission.

In FIG. 1, the number of access points AP constituting the multi AP is two and the number of communication terminals STA is two. However, the number of access points AP constituting the multi AP may be two or more and the number of communication terminals STA may be two or more or one, and the number of access points AP and the number of communication terminals STA do not need to match.

In the following description, the communication terminals STA1 and STA2 are collectively referred to as a communication terminal STAs, but the number of pieces may be one. Furthermore, in the following description, the access point AP may be abbreviated as “AP”, and the communication terminal STA may be abbreviated as “STA”.

Among the access points AP constituting the multi AP, the access point AP that has acquired a transmission right prior to execution of LLR Combining is referred to as a sharing AP, while another access point AP is referred to as a shared AP, and the following roles may be given.

In other words, in a case where the sharing AP operates jointly with the shared AP as the multi AP, after acquiring the transmission right, the sharing AP notifies the shared AP that the sharing AP operates jointly with the shared AP within a transmission time acquired by the sharing AP.

Although details will be described later, when the communication terminal STAs executes uplink transmission, the sharing AP notifies the communication terminal STAs of information (a trigger) for inducing uplink transmission. Here, the “transmission right” of the sharing AP is intended for at least the following time period by the sharing AP. That is, this is a time period from trigger transmission from the sharing AP (or the sharing AP and the shared AP), until uplink transmission from the communication terminal STAs to the sharing AP (or the sharing AP and the shared AP), and notification of information regarding a log-likelihood ratio between the sharing AP and the shared AP.

Furthermore, in a case where LLR Combining is executed, the sharing AP and the shared AP execute notification of a log-likelihood ratio of a data bit transmitted from each communication terminal STA between the access points AP, but the notification of the log-likelihood ratio may be executed from the sharing AP to the shared AP, and the notification of the log-likelihood ratio may be similarly executed from the shared AP to the sharing AP and other shared APs.

Note that frequency channels used in the communication between the multi APs and the communication between the multi AP and the communication terminal STA may be different. For example, communication may be performed in a 6 GHz band between the multi APs, and communication may be performed in a 2.4 GHz band and a 5 GHz band between the multi AP and the communication terminal STA. Similarly, communication between the multi APs may be executed by wired communication such as an optical fiber or a power line.

Furthermore, in LLR Combining, frequency channels used by the individual access points AP for transmission with the communication terminal STA may completely match, or may partially match. For example, when two frequency channels of B₁ and B₂ are used between the access point AP1 and the communication terminal STA, and two frequency channels of B₂ and B₃ are used between the access point AP2 and the communication terminal STA, uplink transmission of data to be a target of LLR Combining may be executed only with the frequency channel B₂.

(Device Configuration)

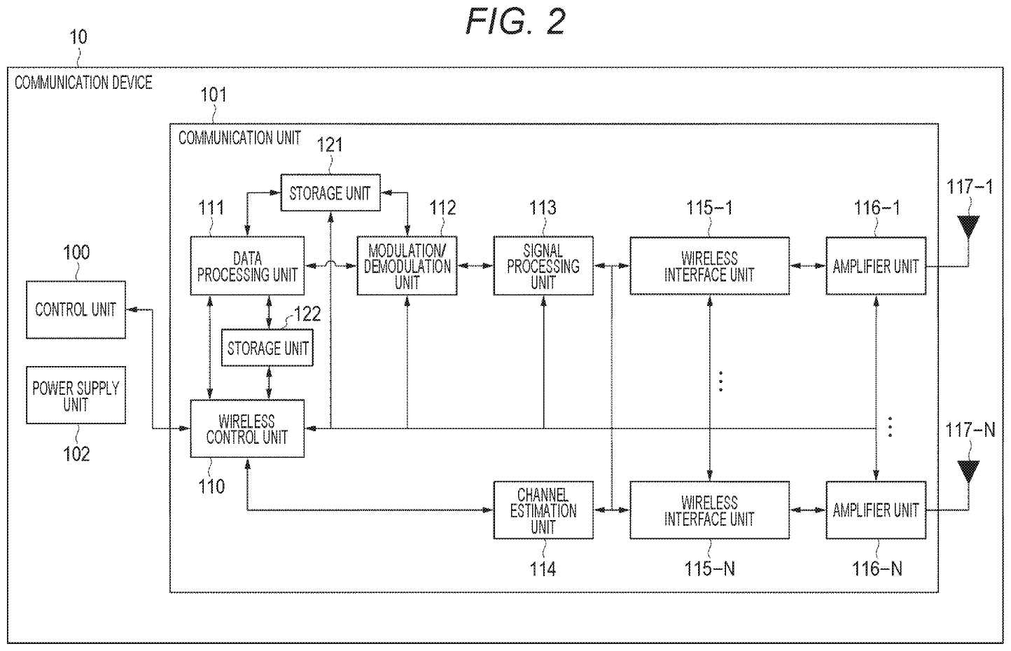

FIG. 2 illustrates a configuration example of an embodiment of a communication device (a wireless communication device) of the present technology.

A communication device 10 illustrated in FIG. 2 is configured as the access point AP or the communication terminal STA in the wireless network system of FIG. 1. That is, a basic configuration is similar between the access point AP and the communication terminal STA.

The communication device 10 includes a control unit 100, a communication unit 101, and a power supply unit 102. The communication unit 101 includes a wireless control unit 110, a data processing unit 111, a modulation/demodulation unit 112, a signal processing unit 113, a channel estimation unit 114, wireless interface units 115-1 to 115-N, amplifier units 116-1 to 116-N, a storage unit 121, and a storage unit 122.

Furthermore, in the communication device 10, antenna units 117-1 to 117-N are provided for (the amplifier units 116-1 to 116-N of) the communication unit 101. Here, N is an integer of 1 or more. A plurality of communication units 101 may be provided. The communication unit 101 may be realized by LSI.

The control unit 100 includes a microprocessor or the like, and controls operation of each unit of the communication device 10. The control unit 100 controls (the wireless control unit 110 of) the communication unit 101 and the power supply unit 102. Furthermore, the control unit 100 may execute at least a part of operation of the wireless control unit 110 instead of the wireless control unit 110.

The wireless control unit 110 exchanges information (data) between individual units. Furthermore, the wireless control unit 110 performs packet scheduling in the data processing unit 111, and parameter setting in the modulation/demodulation unit 112 and the signal processing unit 113. Furthermore, the wireless control unit 110 performs parameter setting and transmission power control in the wireless interface unit 115 and the amplifier unit 116.

The data processing unit 111 generates a packet for wireless communication from input data at a time of transmission when data is inputted from an upper layer or the storage unit 122, executes processing such as addition of a header for media access control (MAC) and addition of an error detection code, and supplies processing data obtained as a result thereof to the modulation/demodulation unit 112.

Furthermore, the data processing unit 111 executes processing such as analysis of a MAC header, detection of a packet error, and reorder processing on input data at a time of reception when data is inputted from the modulation/demodulation unit 112, and outputs processing data obtained as a result thereof to a protocol upper layer.

At the time of transmission, on the basis of a coding scheme and a modulation scheme set by the wireless control unit 110, the modulation/demodulation unit 112 executes processing such as encoding, interleaving, and modulation on input data inputted from the data processing unit 111, and outputs a data symbol stream obtained as a result thereof to the signal processing unit 113.

Furthermore, at the time of reception, on the basis of a decoding scheme and a demodulation scheme set by the wireless control unit 110, the modulation/demodulation unit 112 executes, on the data symbol stream inputted from the signal processing unit 113, processing opposite to that at the time of transmission, that is, processing such as demodulation, deinterleaving, and decoding, and outputs processing data obtained as a result thereof to the data processing unit 111. At the time of reception, in a case where information indicating data to be an execution target of LLR Combining is included in the received data, the modulation/demodulation unit 112 generates (calculates) a log-likelihood ratio and then stores log-likelihood ratio information in the storage unit 121.

The storage unit 121 includes a semiconductor memory such as a random access memory (RAM). At the time of reception by the communication device 10 that executes LLR Combining, which is when there is an input from the signal processing unit 113 in the modulation/demodulation unit 112, information (likelihood information) regarding the log-likelihood ratio generated in the modulation/demodulation unit 112 is inputted to and temporarily stored in the storage unit 121.

In the communication device 10, in a case where the log-likelihood ratio information is notified from another communication device in order to execute LLR Combining, the log-likelihood ratio information stored in the storage unit 121 is outputted to the data processing unit 111 in accordance with a parameter inputted from the wireless control unit 110. Furthermore, in a case where the communication device 10 notifies another communication device of the log-likelihood ratio information existing in the storage unit 121, the log-likelihood ratio information stored in the storage unit 121 is outputted to the data processing unit 111 in accordance with a parameter inputted from the wireless control unit 110.

Note that the log-likelihood ratio information temporarily stored in the storage unit 121 may be stored for every transmission source terminal of a reception signal represented by the log-likelihood ratio. At this time, the log-likelihood ratio stored for every transmission source terminal may be stored with any length. For example, in a case where error correction executed by the modulation unit is a low density parity check (LDPC) code, the log-likelihood ratio may be stored for every block length (or codeword length) of the LDPC. Furthermore, FIG. 2 illustrates a configuration in which the storage unit 121 is provided outside the modulation/demodulation unit 112, but the storage unit 121 may be provided inside the modulation/demodulation unit 112.

The storage unit 122 includes a semiconductor memory such as a RAM. The storage unit 122 temporarily stores an error detection result of a received packet and transmission data for each of any traffic type. At the time of reception, an error detection result of a packet received from the data processing unit 111 is inputted to the storage unit 122, and the error detection result is stored for every packet. This error detection result is outputted to the wireless control unit 110 in order to execute a retransmission request to the transmission source terminal.

At the time of transmission, an amount of transmission data for every traffic type is inputted from the wireless control unit 110 to the storage unit 122, and transmission data of each traffic is sent to the data processing unit 111. Furthermore, in a case where a notification of a data amount of the transmission traffic stored in the storage unit 122 is requested, or in a case where the communication device 10 notifies a destination terminal of a data amount of the transmission traffic held by the self, information indicating a data amount is outputted to the wireless control unit 110 for each of any traffic type existing in the storage unit 122 (an operation of a buffer status report (BSR)).

Note that the storage unit 122 may be connected only to the wireless control unit 110 without being connected to the data processing unit 111. In this case, in accordance with a parameter inputted from the wireless control unit 110, the storage unit 122 may pass information to the wireless control unit 110 to transfer to the data processing unit 111.

At the time of transmission, the signal processing unit 113 executes processing such as signal processing used for spatial separation as necessary on the data symbol stream inputted from the modulation/demodulation unit 112, and outputs one or more transmission symbol streams obtained as a result thereof to each of the wireless interface units 115-1 to 115-N. Note that the signal processing unit 113 may apply transmission (cyclic shift delay (CSD)) by applying any delay amount to every antenna without performing spatial separation.

Furthermore, at the time of reception, the signal processing unit 113 executes processing such as signal processing for spatial decomposition of a stream as necessary on a reception symbol stream inputted from each of the wireless interface units 115-1 to 115-N, and outputs a data symbol stream obtained as a result thereof to the modulation/demodulation unit 112.

The channel estimation unit 114 calculates complex channel gain information of a propagation path from a preamble portion and a training signal portion of input signals from the wireless interface units 115-1 to 115-N each. The complex channel gain information calculated by the channel estimation unit 114 is used for demodulation processing in the modulation/demodulation unit 112 and spatial processing in the signal processing unit 113, via the wireless control unit 110.

At the time of transmission, the wireless interface unit 115-1 converts a transmission symbol stream inputted from the signal processing unit 113 into an analog signal, and executes processing such as filtering, up-conversion to a carrier frequency, and phase control, and outputs (sends) a transmission signal obtained as a result thereof to the amplifier unit 116-1.

Furthermore, at the time of reception, the wireless interface unit 115-1 executes processing opposite to that at the time of transmission, that is, processing such as down-conversion on the reception signal inputted from the amplifier unit 116-1, and outputs a reception symbol stream obtained as a result thereof to the signal processing unit 113. Furthermore, the wireless interface unit 115-1 outputs data obtained by the processing to the channel estimation unit 114.

At the time of transmission, the amplifier unit 116-1 amplifies an analog signal, which is a transmission signal inputted from the wireless interface unit 115-1, to predetermined power, and sends the analog signal to the antenna unit 117-1. Furthermore, at the time of reception, the amplifier unit 116-1 amplifies an analog signal, which is a reception signal inputted from the antenna unit 117-1, to predetermined power, and outputs the analog signal to the wireless interface unit 115-1.

Note that the wireless interface units 115-2 to 115-N are configured similarly to the wireless interface unit 115-1, the amplifier unit 116-2 to the amplifier unit 116-N are configured similarly to the amplifier unit 116-1, and the antenna units 117-2 to 117-N are configured similarly to the antenna unit 117-1, so that the description thereof is omitted here.

Here, the wireless interface units 115-1 to 115-N will be referred to as a wireless interface unit 115 in a case where it is not necessary to particularly distinguish from each other, the amplifier unit 116-1 to the amplifier unit 116-N will be referred to as an amplifier unit 116 in a case where it is not necessary to particularly distinguish from each other, and the antenna units 117-1 to 117-N will be referred to as an antenna units 117 in a case where it is not necessary to particularly distinguish from each other.

At this time, in the amplifier unit 116, (at least a part of) at least one of the function at the time of transmission and the function at the time of reception may be included in the wireless interface unit 115. Furthermore, in the amplifier unit 116, (at least a part of) at least one of the function at the time of transmission or the function at the time of reception may be a component external to the communication unit 101. Moreover, one or more sets of the wireless interface unit 115, the amplifier unit 116, and the antenna unit 117 may be included as a component. Note that the wireless interface unit 115 and the antenna unit 117 may be directly connected without the amplifier unit 116 being provided.

The power supply unit 102 includes a battery power supply or a fixed power supply, and supplies electric power to each unit of the communication device 10.

Note that, in the communication device 10, a plurality of communication units 101 may be installed and connected to one control unit 100. At this time, at least one of the plurality of communication units 101 may be used for communication only with the access point AP. For example, in a case where communication between the access points AP occurs, the communication unit 101 may be used as a dedicated communication unit, and may be operated in a frequency channel different from communication with the communication terminal STA.

(Entire Sequence)

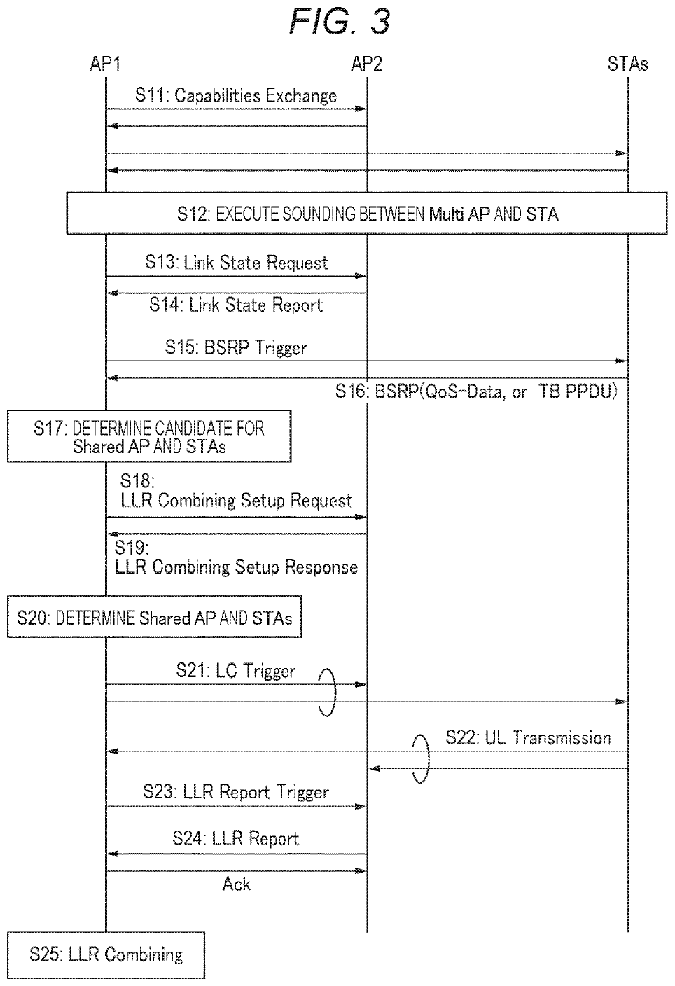

FIG. 3 illustrates an example of an entire sequence of the present technology.

In FIG. 3, similarly to the wireless network system of FIG. 1, it is assumed that there are two access points AP of AP1 and AP2 constituting the multi AP, and there is a communication terminal STAs of one or more pieces (STA1, STA2, and the like).

(S11: Capabilities Exchange)

First, the access points AP1 and AP2 and the communication terminal STAs mutually execute information notification (capability notification: Capabilities Exchange) regarding a capability of the own terminal (S11 in FIG. 3). The capability referred to herein refers to whether or not LLR Combining described later can be executed and an upper limit (hereinafter, referred to as a buffer size) of an information amount of a log-likelihood ratio and information regarding a log-likelihood ratio that can be temporarily stored in the access point AP, but is not limited thereto.

Capability Exchange may be executed by being included in, for example, a beacon signal periodically transmitted by each access point AP or information notification (Association) for connecting the access point AP of each to operate as the multi AP.

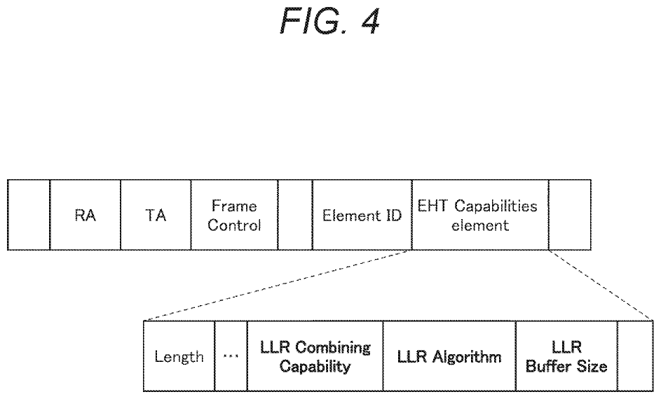

FIG. 4 illustrates a configuration example of a frame whose notification is provided in Capabilities Exchange.

This frame includes RA, TA, Frame Control, Element ID, and Extremely High Throughput (EHT) Capabilities element. However, the components of the frame are not limited to these.

The receiver address (RA) and the transmitter address (TA) respectively include information indicating a destination terminal and information indicating a transmission source terminal. For example, in the RA and the TA, a media access control (MAC) address specific to the terminal may be indicated, or identification information specific to the multi AP may be indicated.

The Frame Control includes information indicating that the frame is a frame whose notification is provided in Capabilities Exchange. The Element ID includes information indicating that the element is an EHT Capabilities element.

The EHT Capabilities element includes information regarding whether or not LLR Combining can be executed, an algorithm for calculating a log-likelihood ratio, and a buffer size. The EHT Capabilities element internally includes at least one of fields of Length, Element ID, LLR Combining Capability, LLR Algorithm, and LLR Buffer Size.

The Length includes information indicating a bit length of the EHT Capabilities element. The LLR Combining Capability includes information regarding whether or not LLR Combining can be executed in the terminal notifying of the frame.

The LLR Algorithm includes information regarding a calculation algorithm for a log-likelihood ratio in the terminal notifying of the frame. The LLR Buffer Size includes information indicating an upper limit of a buffer size, which is an information amount of a log-likelihood ratio and information regarding the log-likelihood ratio (likelihood information) that can be temporarily stored in the terminal notifying of the frame.

Information as follows may be included as a specific example of the LLR Combining Capability field. Here, the LLR Combining Capability field is assumed to have a 1-bit length. “0” indicates that LLR Combining cannot be executed, and “1” indicates that LLR Combining can be executed.

Furthermore, information as follows may be included as a specific example of the LLR Algorithm field. Here, it is assumed that a log-likelihood ratio is determined on the basis of a Euclidean distance |y−xᵢ|² of a complex planar shape between a complex symbol y of a reception signal after channel equalization processing and an i-th complex symbol candidate point xᵢ of a transmission signal.

When the LLR Algorithm has a 1-bit length, “0” indicates that the log-likelihood ratio can be calculated on the basis of Euclidean distances for complex symbol candidate points of all the transmission signals, and “1” indicates that the log-likelihood ratio is calculated on the basis of not the complex symbol candidate points of all the transmission signals but only Euclidean distances for complex symbol candidate points of some transmission signals. Note that a selection rule for the some transmission signals may conform to a specific threshold value, and information indicating this threshold value may be included.

For example, in a case where the Euclidean distance cannot be obtained for the complex symbol candidate points of all the transmission signals due to a computation processing capability of the communication terminal, or in a case of computation for the purpose of power saving, the log-likelihood ratio is calculated only on the basis of Euclidean distances for complex symbol candidate points of some transmission signals.

Furthermore, as a specific example of the LLR Buffer Size field, in a case where the LLR Buffer Size has a 12-bit length, an upper limit of the buffer size may be indicated as follows. Here, in the 14 bit length of the LLR Buffer Size, in a case where the upper 4 bits indicate a unit (or a scaling factor) G (bytes) representing a buffer size, the lower 10 bits indicate a normalized information amount in which the unit G is 1, and an upper limit of the buffer size is B (bytes), the value B indicated by the LLR Buffer Size (a wavy line (˜) is written above B) may be expressed by the following Equation (2).

$$[ Formula 2 ]$$

$$\tilde{B} = ⌊ B / G ⌋ G , s . t . \cdot \cdot ⌊ B / G ⌋ = {\sum }_{i = 1}^{10} {X}_{i} \times {2}^{( i - 1 )} , {log}_{10} G = {\sum }_{j = 1}^{4} {Y}_{j} \times {2}^{( j - 1 )} \qquad ( 2 )$$

However, in Equation (2), for any number x, |x| represents a maximum integer that does not exceed x, and a value of an i-th lower bit of the 10-bit length information representing a standardized information amount is denoted by Xᵢ, and a value of a j-th lower bit of the 4-bit length representing a scaling factor is denoted by Yⱼ.

(S12: Sounding Between Multi AP and STA)

The access point AP and the communication terminal STAs that have executed Capabilities Exchange execute sounding for propagation path estimation between the multi AP and each communication terminal STA (S12 in FIG. 3).

Here, as described in Document 4 below, a known sequence may be transmitted from the multi AP to each communication terminal STA on the basis of a trigger, and each communication terminal STA that has received the known sequence may notify the multi AP of information (channel state information (CSI)) regarding the estimated propagation path.

Document 4: Kosuke Aio, et al., “Consideration on Multi AP Sounding,” IEEE 802.11-19/1134r1, 2019

Alternatively, although not illustrated in FIG. 3, in a case where the access points AP1 and AP2 can observe reception signal power and link quality in accordance with a signal transmitted from each communication terminal STA, sounding does not need to be executed.

(S13: Link State Request, S14: Link State Report)

The access point AP2 that has estimated link quality between the access point AP and each communication terminal STA by sounding or the like notifies the access point AP1 of the estimated link quality.

Here, information notification (Link State Request) for requesting notification of the link quality is executed first from the access point AP1 (S13 in FIG. 3), and the access point AP2 subjected to Link State Request executes, to the access point AP1, information notification (Link State Report) indicating the link quality between the access point AP2 and the communication terminal STAs (S14 in FIG. 3).

Furthermore, each access point AP may estimate the link quality between the access point AP1 and the access point AP2 on the basis of the signal quality received by Link State Request and Link State Report.

(S15: BSRP Trigger, S16: BSRP)

The communication terminal STAs may notify (BSRP) the access point AP1 of a traffic information amount to be transmitted by the communication terminal STA using LLR Combining. Here, the communication terminal STAs that has received BSRP Trigger from the access point AP1 executes BSRP (S15 and S16 in FIG. 3).

Note that S16 in FIG. 3 may be executed according to a buffer status report protocol (BSRP) disclosed in Document 1 described above.

(S17: Determination of Candidate for Shared AP and STAs)

The access point AP1 selects, as a sharing AP, the communication terminal STAs that executes uplink transmission in a case of executing LLR Combining, and selects a shared AP that jointly operates in LLR Combining.

At this time, in the access point AP1, in a case where the link quality between the APs has been estimated, and the link quality between the multi AP and the communication terminal STA and the traffic amount of each communication terminal STA have been notified, the access point AP1 may determine the shared AP and the communication terminal STAs as described below.

Here, R_{STAj} represents a point-to-point (P2P) estimated transmission rate in a case where LLR Combining is not executed in the access point AP1 (AP1) and a j-th STA, R_{APi} represents a P2P estimated transmission rate between the access point AP1 (AP1) and an i-th Shared AP, and R_{APi-STAj} represents a P2P estimated transmission rate between an i-th candidate of the shared AP and the j-th STA. These estimated transmission rates may be calculated on the basis of the estimated link quality between APs held by the access point AP1 and link quality between the multi APs.

Note that the link quality between the multi APs may be estimated by executing Link State Request (S13 in FIG. 3) and Link State Report (S14 in FIG. 3), and the link quality between the access point AP1 and each communication terminal STA may be estimated by executing BSRP (S16 in FIG. 3).

At this time, the i-th candidate of the shared AP and the j-th STA that simultaneously satisfy the following Formulas (3) and (4) may be set as candidates of the shared AP and the communication terminal STA that execute LLR Combining when the access point AP1 is the sharing AP (S17 in FIG. 3).

$$[ Formula 3 ]$$

$${R}_{{STA}_{j}} < \frac{1}{\frac{K}{{R}_{{AP}_{i}}} + \frac{K}{{R}_{{AP}_{i} - {STA}_{j}}}} \qquad ( 3 )$$

$$[ Formula 4 ]$$

$${T}_{{STA}_{j}} \leq min ( {B}_{AP 1} , {B}_{Shared \cdot AP \# i} ) \qquad ( 4 )$$

Here, K represents a quantum bit depth when one log-likelihood ratio is represented by a bit, and B_{AP1} and B_{Shared AP #i} respectively represent a maximum value of a buffer size in the access point AP1 (AP1) and a maximum value of a buffer size of the i-th candidate of the shared AP. T_{STAj} represents an amount of information regarding a log-likelihood ratio that should be temporarily held by each access point AP with respect to a traffic amount held by the j-th STA. T_{STAj} may be represented by, for example, a product of the following (a1) to (a3).

(a1) a bit length when a traffic amount held by the j-th STA is converted into a MAC protocol data unit (MPDU)

(a2) an encoding rate in an error correction code

(a3) a minimum value of a maximum bit length in which each access point AP can express a 1-bit log-likelihood ratio

Note that, in a case where there is only one candidate for the shared AP, or in a case where a time for executing LLR Combining with a specific communication terminal STAs and the shared AP is determined in advance, the shared AP that jointly operates in LLR Combining and the communication terminal STA that transmits data to the multi AP in LLR Combining may be determined as an access point AP already connected to the access point AP1 and the communication terminal STA determined in advance.

(S18: LLR Combining Setup Request)

Prior to execution of LLR Combining, in uplink transmission of the communication terminal STAs, the access point AP1 that has determined candidates for the shared AP for joint operation and the communication terminal STAs for transmission executes an execution request for LLR Combining (LLR Combining Setup Request) to the shared AP (S18 in FIG. 3). Here, it is assumed that the access point AP1 executes LLR Combining Setup Request after acquiring a transmission right, and the access point AP2 has been selected as a candidate for the shared AP.

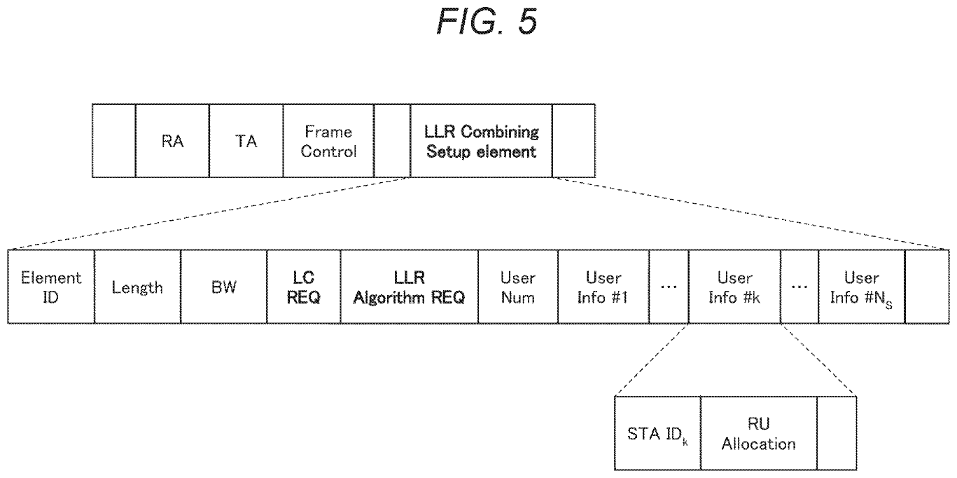

FIG. 5 illustrates a configuration example of a frame whose notification is provided in LLR Combining Setup Request.

This frame includes RA, TA, Frame Control, and LLR Combining Setup element. However, the components of the frame are not limited to these.

The RA and the TA respectively include information indicating a destination terminal and information indicating a transmission source terminal. For example, in the RA and the TA, a MAC address specific to the terminal may be indicated, but identification information specific to the multi AP may be indicated in a case where a destination is a plurality of access points AP constituting the multi AP.

The Frame Control includes information indicating that the frame is a frame whose notification is provided in LLR Combining Setup Request.

The LLR Combining Setup element includes information regarding an execution request for LLR Combining. The LLR Combining Setup element internally includes at least one of fields of Element ID, Length, BW, LC REQ, LLR Algorithm REQ, User Num, and User Info #1 to #N_{S}.

The Element ID includes information indicating that the element is the LLR Combining Setup element. The Length includes information regarding a bit length of the LLR Combining Setup element. The BW includes information indicating, by the terminal notifying of the frame to the destination terminal, “a frequency band to be a calculation target of a log-likelihood ratio for a signal transmitted from the communication terminal STAs in UL Transmission” requested to the destination terminal.

LLR Combining Request (LC REQ) includes information indicating an execution request for LLR Combining. The LLR Algorithm REQ includes information indicating a requested range of a ratio calculation algorithm for a log-likelihood ratio.

The User Num includes information indicating a number of fields N_{S} of the subsequent User Info. Each of the User Info #1 to #N_{S} includes information regarding each communication terminal STA that is an execution target candidate of LLR Combining in UL Transmission. In particular, each User Info indicates information for each different communication terminal STA, and includes subfields of STA IDₖ and RU Allocation.

The STA IDₖ includes information indicating the communication terminal STA that is a target of information indicated in the User Info #k. The RU Allocation includes information indicating, by the terminal transmitting the frame, a requested range of a frequency resource that is a target of a log likelihood to be notified to the terminal after UL Transmission, in information notification (LLR Report) regarding the log-likelihood ratio.

Note that the information indicated by the STA IDₖ in the frame may be an association ID (AID) of IEEE 802.11 as an information format. Furthermore, the RU Allocation may indicate a frequency resource together with information included in the BW field. Furthermore, the LLR Algorithm REQ may include information indicating contents included in a calculation algorithm for the log-likelihood ratio that can be executed by the access point AP2 and is indicated in the LLR Algorithm field in the frame whose notification has been provided in advance in Capability Exchange.

(S19: LLR Combining Setup Response)

The access point AP2 subjected to LLR Combining Request executes information notification (LLR Combining Setup Response) to the access point AP1 (S19 in FIG. 3). This information notification includes whether or not joint operation in LLR Combining is possible, an information amount of information regarding a log-likelihood ratio that can be temporarily stored in the access point AP2, and notification of information regarding “the communication terminal STAs that is an execution target candidate of LLR Combining in UL Transmission” requested by the access point AP2.

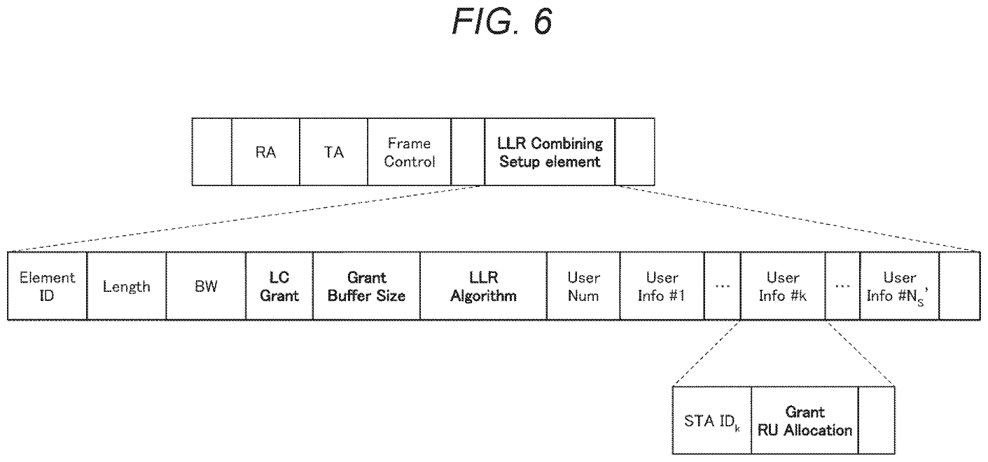

FIG. 6 illustrates a configuration example of a frame whose notification is provided in LLR Combining Setup Response.

This frame includes RA, TA, Frame Control, and LLR Combining Setup element. However, the components of the frame are not limited to these.

The RA and the TA respectively include information indicating a destination terminal and information indicating a transmission source terminal. The Frame Control includes information indicating that the frame is a frame whose notification is provided in LLR Combining Setup Response.

The LLR Combining Setup element includes information regarding execution of LLR Combining. Note that, although not illustrated in the figure, in a case where information for identifying a plurality of pieces of LLR Combining Setup Request is included in LLR Combining Setup Request, LLR Combining Setup Response may include information indicating corresponding LLR Combining Setup Request. As this information, a dialog token of IEEE 802.11 may be used.

Furthermore, the LLR Combining Setup element internally includes at least one of fields of Element ID, Length, BW, LC Grant, Grant Buffer Size, LLR Algorithm, User Num, and User Info #1 to #N_{S}′.

The Element ID includes information indicating that the element is the LLR Combining Setup element. The Length includes information regarding a bit length of the LLR Combining Setup element. The BW includes information indicating, by the terminal notifying of the frame, a frequency band as a calculation target of a log-likelihood ratio for a signal transmitted from the communication terminal STA in UL Transmission. Note that, in a case where the target frequency band is the same information as the BW in the LLR Combining Setup element in the frame whose notification has been provided in LLR Combining Setup Request executed immediately before, the BW does not need to be present.

The LC Grant includes information indicating whether or not joint operation is possible in LLR Combining by the access point AP notifying of the frame, for the notified LLR Combining Setup Request.

In a case where the LC Grant indicates that joint operation in LLR Combining is possible, the Grant Buffer Size includes information indicating an upper limit of an information amount related to a log-likelihood ratio that can be temporarily stored by the terminal notifying of the frame after UL Transmission. The LLR Algorithm includes information indicating a requested range of a calculation algorithm for a log-likelihood ratio.

The User Num includes information indicating N_{S}′ which is the number of subsequent User Info fields. Each of the User Info #1 to #N_{S}′ includes information regarding a candidate of the communication terminal STAs to be a notification target of the access point AP2 in subsequent LLR Report, in the communication terminals STA indicated by the User Info in the frame whose notification has been provided in LLR Combining Setup Request executed immediately before.

Note that, in a case where candidates of the communication terminal STA to be a notification target of the access point AP2 in subsequent LLR Report are all communication terminals STA indicated by the User Info in the frame whose notification has been provided in LLR Combining Setup Request executed immediately before, information indicating this fact may be included in the LC Grant. At this time, the User Info and the User Num do not need to be present. Furthermore, in a case where the LC Grant includes information indicating that joint operation in LLR Combining is not to be performed, the subsequent Grant Buffer Size, User Num, and User Info do not need to be present.

Furthermore, each User Info indicates information for one different communication terminal STA, and includes subfields of STA IDₖ and Grant RU Allocation.

The STA IDₖ includes information indicating the communication terminal STA as a target of information indicated in the User Info #k. The Grant RU Allocation includes information indicating a target frequency resource in information notification (LLR Report) regarding a log-likelihood ratio by the access point AP2 to the access point AP1 after UL transmission.

Note that the communication terminal STA indicated by the STA IDₖ in the frame may be selected from a set of communication terminals STA indicated by each User Info notified in corresponding LLR Combining Setup Request, and may be an association ID (AID) of IEEE 802.11 as an information format. Furthermore, the Grant RU Allocation may indicate a frequency resource together with information included in the BW field.

(S20: Determination of Shared AP and STAs)

In a case where the access point AP1 notified of LLR Combining Setup Response operates as the sharing AP itself and executes LLR Combining, the access point AP1 determines the shared AP for joint operation and the communication terminal STAs to be permitted for transmission in UL Transmission (S20 in FIG. 3).

At this time, the shared AP is selected from among the access points AP indicated to be capable of joint operation in the LC Grant, in the frame whose notification is provided in LLR Combining Setup Response. Similarly, the communication terminal STA that is permitted for transmission in UL Transmission and is to be an execution target of LLR Combining is selected from among the communication terminals STA indicated in the User Info in the frame whose notification is provided in LLR Combining Setup Response.

(S21: LC Trigger)

Prior to execution of LLR Combining, the access point AP1 that has determined the shared AP (AP2) for joint operation in LLR Combining and the communication terminal STAs for transmission executes information notification (LC Trigger) prompting execution of UL Transmission to the communication terminal STAs and the shared AP (AP2) (S21 in FIG. 3). The communication terminal STAs subjected to LC Trigger transmits data to the access point AP1 or to both the access points AP1 and AP2.

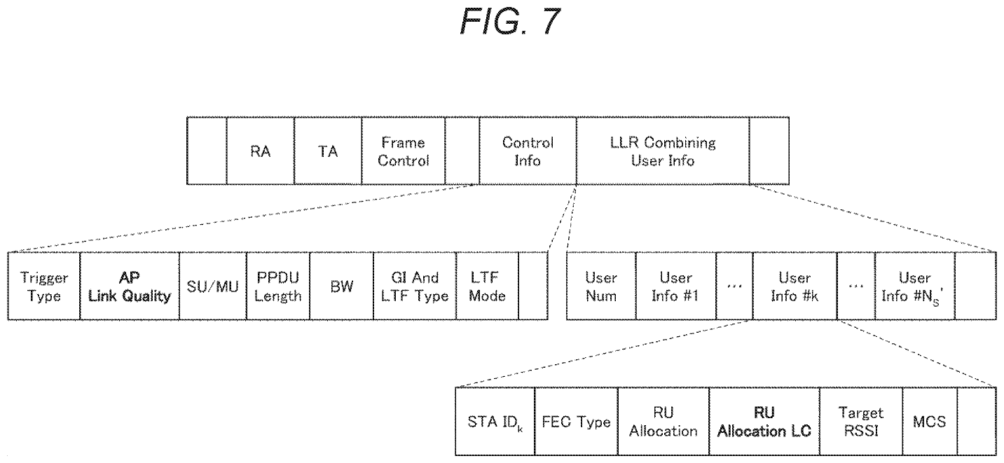

FIG. 7 illustrates a configuration example of a frame whose notification is provided in LC Trigger.

This frame includes RA, TA, Frame Control, Control Info, and LLR Combining User Info. However, the components of the frame are not limited to these.

The RA and the TA respectively include information indicating a destination terminal and information indicating a transmission source terminal. The Frame Control includes information indicating that the frame is a frame whose notification is provided in LC Trigger.

The Control Info and the LLR Combining User Info include information regarding a communication parameter when the communication terminal STA that has received LC Trigger transmits data to the access point AP1 or to both the access points AP1 and AP2 in UL Transmission, while the Control Info includes information that is commonly notified to the communication terminals STA, and the LLR Combining User Info includes different information for each communication terminal STA.

However, the Frame Control may include information to indicate that the frame is a frame whose notification is provided in LC Trigger together with information indicated by Trigger Type in the Control Info.

Furthermore, the Control Info includes at least one of subfields of Trigger Type, AP Link Quality, SU/MU, PPDU Length, BW, GI And LTF Type, or LTF Mode.

The Trigger Type includes information indicating that the frame is a frame whose notification is provided in LC Trigger, by being used together with information included in the Frame Control. The AP Link Quality includes information indicating link quality between the access point AP1 and the access point AP2.

The SU/MU includes information indicating whether the number of pieces of the communication terminal STAs for transmission is one piece (single user: SU) or a plurality of pieces (multi user: MU), in subsequent data transmission (UL Transmission). The PPDU Length includes information regarding a length of data (PHY Protocol Data Unit (PPDU)) transmitted by the communication terminal STA that performs transmission in UL Transmission.

The BW includes information indicating a frequency band to be used by the communication terminal STA that performs transmission in UL Transmission. The GI And LTF Type includes information indicating a guard interval (GI) length to be used by the communication terminal STA that performs transmission in UL Transmission and indicating a known sequence (a long training field: LTF) length for channel estimation and frequency synchronization. The LTF Mode includes information indicating whether or not a known sequence is made orthogonal in a code domain between the communication terminals STA in UL Transmission.

However, the BW may include information indicating a frequency resource to be allocated to each communication terminal STA, by being used together with RU Allocation in the User Info. Furthermore, in a case where the SU/MU includes information indicating that only one communication terminal STA performs transmission in UL Transmission, the GI And LTF Type and the LTF Mode do not need to be present, and the PPDU Length may include information indicating an upper limit of a data length to be transmitted by the communication terminal STA that performs transmission in UL Transmission.

Furthermore, in a case where the SU/MU includes information indicating that a plurality of communication terminals STA performs transmission in UL Transmission, the PPDU Length may include information indicating a data length to be transmitted by the communication terminal STA that performs transmission in UL Transmission.

The LLR Combining User Info includes at least one of fields of User Num and User Info #1 to #N_{S}′.

The User Num includes information indicating a number of fields N_{S}′ of the subsequent User Info. The User Info #1 to #N_{S}′ include information regarding parameters to be used in UL Transmission for each communication terminal STA to be permitted for transmission in UL Transmission.

Note that, in a case where the SU/MU includes information indicating that only one communication terminal STA performs transmission in UL Transmission, the number pieces of User Info is one, and User Num does not need to be present.

Each User Info field internally includes at least one of subfields of STA IDₖ, FEC Type, RU Allocation, RU Allocation LC, Target RSSI, or MCS. Here, any one piece of the User Info is assumed to be User Info #k (1≤k≤N_{S}′).

The STA IDₖ includes information uniquely identifying the communication terminal STA. The FEC Type includes information regarding an error correction code (forward error check (FEC)) to be used in UL Transmission. The RU Allocation includes information indicating a frequency resource to be used in UL Transmission by the communication terminal STA indicated by the STA IDₖ.

The RU Allocation LC includes information indicating a frequency resource to be a target of LLR Combining, among frequency resources to be used in UL Transmission by the communication terminal STA indicated by the STA IDₖ. The Target RSSI includes information indicating a target value of reception power at the access point AP1 or at both the access points AP1 and AP2, for which the communication terminal STA indicated by the STA IDₖ is to be a destination in UL Transmission. The MCS includes information indicating a range of a coding scheme (a modulation and coding scheme: MCS) to be used in UL Transmission by the communication terminal STA indicated by the STA IDₖ.

However, in the RU Allocation, the frequency resource to be used by the communication terminal STA may be interpreted together with information indicated by the BW in the Control Info. Furthermore, in a case where the SU/MU in the Control Info includes information indicating that only one communication terminal STA performs transmission in UL Transmission, the STA IDₖ, the FEC Type, and the Target RSSI do not need to be included in the User Infok, and the MCS subfield may include information indicating a range of a coding scheme to be used by STAk in UL Transmission.

Furthermore, in a case where the SU/MU in the Control Info includes information indicating that a plurality of communication terminals STA performs transmission in UL Transmission, the MCS subfield may include information indicating a coding scheme to be used by the STAk in UL Transmission. Furthermore, in a case where the frequency resource indicated by the RU Allocation includes other frequency resources in addition to the frequency resource indicated by the RU Allocation LC, the MCS subfield may include information indicating the frequency resource indicated by the RU Allcation LC and the coding scheme for each of other frequency resources.

Furthermore, in a case where all the frequency resources indicated by the RU Allocation match the frequency resources to be a target of LLR Combining in UL Transmission, or are not to be a target of LLR Combining, the RU Allocation LC may include information indicating these as a flag for executing LLR Combining. That is, for example, in a case where the RU Allocation LC has a 1-bit length, information may be used indicating that LLR Combining is not executed on the target communication terminal STA in a case of the RU Allocation LC=“0” and LLR Combining is executed on the target communication terminal STA in a case of the RU Allocation LC=“1”.

(S22: UL Transmission)

The communication terminal STAs subjected to LC Trigger determines transmission parameters on the basis of the information notified in LC Trigger, and executes data transmission (UL Transmission) to the access point AP1 or to both the access points AP1 and AP2 (S22 in FIG. 3).

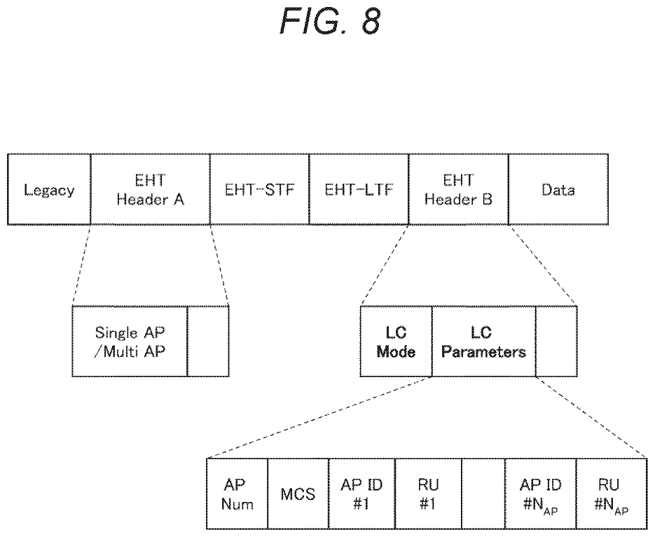

FIG. 8 illustrates a configuration example of a data unit transmitted in UL Transmission.

This data unit includes Legacy, EHT Header A, EHT-short training frame (STF), EHT-long training frame (LTF), EHT Header B, and Data. However, the components of the data unit are not limited to these.

The Legacy includes a known sequence for performing auto gain control (AGC), time synchronization and frequency synchronization, and channel estimation for the purpose of demodulation of subsequent EHT Header A, and information indicating a data unit length. The EHT Header A includes frequency resources occupied by subsequent data and information indicating whether or not the number of access points AP as a destination is one in UL Transmission.

The EHT-STF further includes a known sequence for time synchronization and AGC in a receiving terminal of the data unit, in addition to the Legacy. The EHT-LTF includes a known sequence for performing channel estimation with each transmission antenna that transmits the data unit, in the receiving terminal of the data unit.

The EHT Header B includes information regarding a coding scheme and whether or not LLR Combining can be executed in the terminal that has received the data unit. The Data includes data other than the above-described data transmitted from the terminal transmitting the data unit to the destination terminal.

These fields may be transmitted by an orthogonal frequency division multiplexing (OFDM) modulation scheme. In particular, the EHT-STF may be a signal whose waveform is repeated at any period, and the EHT-LTF may be a signal according to different sequences orthogonal to each other among all transmission antennas in a plurality of access points AP that transmits the data unit.

Furthermore, in a case where a plurality of communication terminals STA simultaneously performs transmission in UL Transmission, the EHT Header B may be transmitted so as to be orthogonal in one or both of code and frequency resource so that the individual communication terminals STA can be separated. For allocation of the frequency resources at this time, it is possible to use a frequency resource indicated by the RU Allocation in each User Info in the LLR Combining User Info in the frame whose notification has been provided in LC Trigger and which is executed immediately before. That is, the RU Allocation is orthogonal for every communication terminal STA, and the receiving terminal can separate simultaneously received data for every communication terminal STA by using the frequency resources described herein.

Similarly, in the case of being orthogonal in code, the orthogonal sequence may be used in accordance with the number allocated to the User Info in the LLR Combining User Info in the frame whose notification has been provided in LC Trigger immediately before. The orthogonal sequence used at this time may be a Hadamard matrix, and may be according to the LTF generation method indicated in Document 1 (IEEE 802.11, 2016) described above.

Furthermore, when the number of communication terminals STA that perform transmission in UL Transmission is one, the EHT Header A may include a field of Single AP/Multi AP. The Single AP/Multi AP includes information indicating whether or not to be a case where the communication terminals STA other than the own terminal as a destination simultaneously perform transmission in UL Transmission, and information indicating a data unit length to be transmitted.

Note that, as a criterion for the terminal that transmits the frame to determine whether or not the number of communication terminals STA that perform transmission in UL Transmission is one, a case may be used in which the SU/MU in the Control Info in the frame whose notification has been provided in LC Trigger immediately before includes information indicating that only one communication terminal STA performs transmission in UL Transmission, and the self is designated in the LLR Combining User Info in the frame.

Furthermore, a receiving terminal that can demodulate the Legacy and can demodulate the EHT Header A may preferentially interpret the data unit length indicated in the field instead of the Legacy, when interpreting the transmitted data unit length.

The EHT Header B includes fields of LC Mode and LC Parameters. The LC Mode includes information regarding whether or not LLR Combining can be executed in the terminal that has received the data unit. The LC Parameters includes a coding scheme to be used in the subsequent Data, information regarding the access point AP as a destination, and information regarding frequency resources.

Furthermore, the LC Parameters includes at least one of subfields of AP Num, MCS, AP ID, and RU.

The AP Num includes information indicating the number of subfields of the subsequent AP ID and RU. The MCS includes information indicating a coding scheme to be used in the subsequent Data. When a k-th AP ID and RU are defined as an AP ID #k and an RU #k, the AP ID #k includes information indicating a k-th AP as a destination, and the RU #k includes information indicating a frequency resource to be used for subsequent data transmission for transmitting to the k-th AP as a destination.

Note that the AP ID #1 may be information indicating the access point AP that requests execution of LLR Combining. Furthermore, in a case where a plurality of communication terminals STA simultaneously performs transmission in UL Transmission, but in a case where the LC Mode indicates that LLR Combining is not executed in the terminal that has received the data unit in some of the communication terminals STA, the AP Num in the LC Parameters in the data unit transmitted by the communication terminal STA may indicate that the number of the access points AP as a destination is one. That is, the destination AP Num and the destination AP ID do not need to be matched between the communication terminals STA.

Furthermore, the MCS subfield may include information indicating a coding scheme for each of any frequency resource. For example, in a case where the AP Num includes information indicating that there are two access points AP as a destination, the RU #1 includes information indicating two frequency resources f₁ and f₂, and the RU #2 includes information indicating one frequency resource f₂, the MCS subfield may indicate a coding scheme for each of the frequency resources of f₁ and f₂. At this time, in the subsequent Data, each frequency resource is subjected to multi-level modulation and coding by the coding scheme indicated in the MCS subfield.

Furthermore, regarding RU #k in the data unit transmitted by one communication terminal STA, in a case where frequency resources to be used for data transmission are equal to each other for a plurality of access points AP as a destination, the RU may not be present for every AP ID and only one piece may be present. That is, it suffices that only one RU subfield common to a plurality of access points AP as a destination is defined.

Here, a correspondence between the frequency resource and the CW in the Data will be described. In the LC Parameters, the communication terminal STA that transmits the data unit including information indicating the number of the plurality of access points AP in the AP Num may allocate the CW to the frequency resource in Data as follows. Note that, here, it is assumed that a waveform is modulated by an OFDM modulation scheme.

Hereinafter, as illustrated in FIG. 8, it is assumed that the number of access points AP indicated by the AP Num is N_{AP}, and a frequency resource indicated by RU #k which is a k-th (1≤k≤N_{AP}) RU subfield is Fₖ. Here, as an example, it is assumed that the AP ID #1 indicates the sharing AP that is an execution request target of LLR Combining. Furthermore, it is assumed that, as the frequency resource indicated by F₁, a frequency resource is selected in which there is a set relationship (that is, F₁⊇Fₖ) including Fₖ′ (2≤k′≤N_{AP}), and Fₖ′ does not overlap with each other (that is, a product set is an empty set) for a different k′. Furthermore, it is assumed that the access point AP indicated by the AP ID #k′ notifies the sharing AP of a log-likelihood ratio in LLR Report, and LLR Combining is executed in the sharing AP.

At this time, each CW generated in the terminal that transmits the data unit may be allocated only to any one Fₖ′ to generate a signal. By generating the Data as described above, the shared AP that is indicated by the AP ID #k′ and to which the data unit is transmitted can correctly execute the error correction processing with a signal of only the frequency resource indicated by RU #k in the received Data.

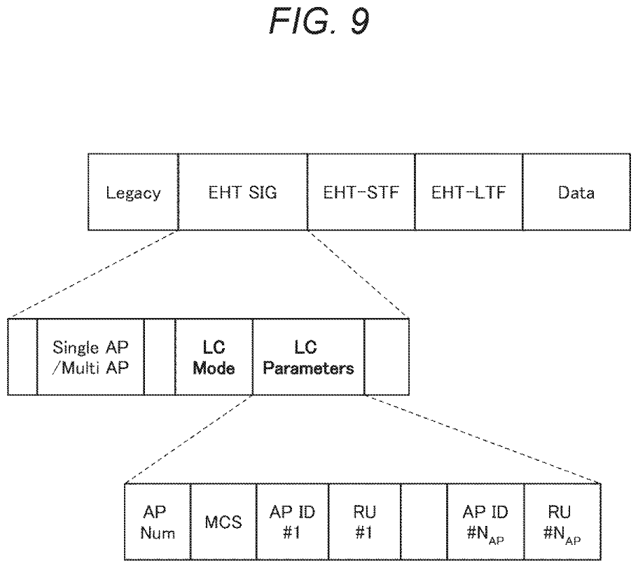

Note that FIG. 9 illustrates another configuration example of a data unit transmitted in UL Transmission. The data unit in FIG. 9 is different from the data unit in FIG. 8 in that EHT-Header A and EHT-Header B are defined in one field as EHT Signal (SIG), but other subfields are similar to those of the data unit in FIG. 8.

(S23: LLR Report Trigger)

The access point AP1 subjected to UL Transmission may execute, to the access point AP2, information notification (LLR Report Trigger) inducing information notification (LLR Report) regarding an LLR of data received by the access point AP2 from the communication terminal STAs (S23 in FIG. 3).

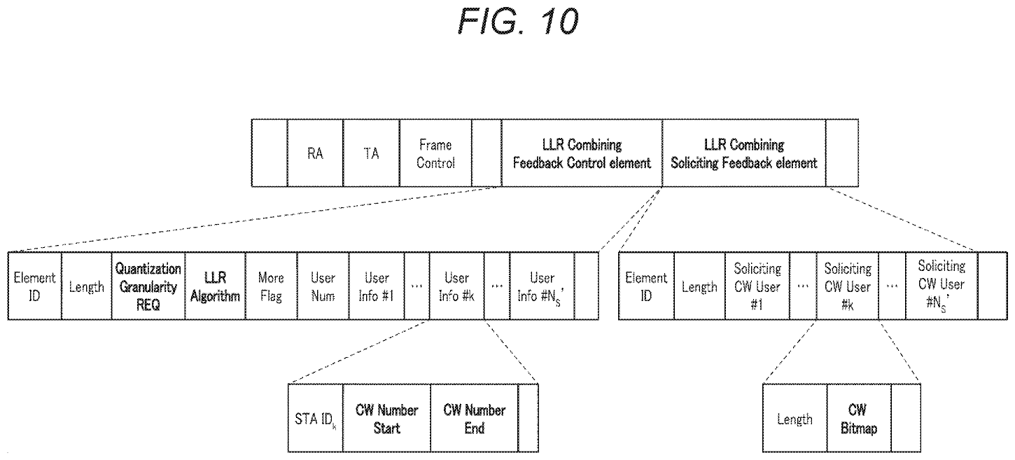

FIG. 10 illustrates a configuration example of a frame whose notification is provided in LLR Report Trigger.

This frame includes RA, TA, Frame Control, LLR Combining Feedback Control element, and LLR Combining Soliciting Feedback element. However, the components of the frame are not limited to these.

The RA and the TA respectively include information indicating a destination terminal and information indicating a transmission source terminal. The Frame Control includes information indicating that the frame is a frame whose notification is provided in LLR Report Trigger.

However, the Frame Control does not need to include information indicating, by the Frame Control alone, that the frame is a frame whose notification is provided in LLR Report Trigger, but may include information indicating that the frame is a frame whose notification is provided in LLR Report Trigger together with information indicated in other fields.

The LLR Combining Feedback Control element includes information regarding the subsequent LLR Combining Soliciting Feedback element. The LLR Combining Soliciting Feedback element includes information regarding an LLR for which the access point AP1 requests the access point AP2 for notification.

The LLR Combining Feedback Control element includes fields of Element ID, Length, Quantization Granularity REQ, LLR Algorithm, More Flag, User Num, and User Info.

The Element ID includes information indicating that the element is the LLR Combining Feedback Control element. The Length includes information indicating a bit length or an octet length of the element.

The Quantization Granularity REQ includes information indicating a resolution of the LLR to be requested. The LLR Algorithm includes information indicating an LLR calculation algorithm to be requested. The More Flag includes information indicating that fragmentation is performed in a case where the element or the subsequent LLR Combining Soliciting Feedback frame is fragmented and information indicating the number of fragmented frames not transmitted.

The User Num includes information indicating the number of fields of the subsequent User Info and the number of fields of Soliciting CW User in the subsequent LLR Combining Soliciting Feedback element. Furthermore, k-th User Info (hereinafter, described as User Info #k) includes subfields of STA IDₖ, CW Number Start, and CW Number End.

The STA IDₖ includes information indicating the communication terminal STA that is a target of information indicated in the User Info #k. The CW Number Start includes information indicating a head number of a codeword (CW) to be requested. The CW Number End includes information indicating an end number of the CW to be requested.

Note that the information included in the STA ID may be an association ID (AID) in Document 1 (IEEE 802.11, 2016) described above, and the communication terminals STA indicated by the STA ID in each User Info do not need to overlap. Furthermore, in a case where a bit length of CW Bitmap in the subsequent LLR Combining Soliciting Feedback element is known between the transmitting terminal and the receiving terminal, the CW Number End does not need to be present.

Furthermore, as information included in the Quantization Granularity REQ, information may be included indicating a threshold value to be used in the access point AP to be notified of the frame, as in (b1) or (b2) below.

(b1) In a case where a coefficient of variance for an absolute value of a log-likelihood ratio is greater than the threshold value for the log-likelihood ratio for the communication terminal STA indicated in each User Info subfield, the access point AP notified of the frame does not need to notify of a log-likelihood ratio of the corresponding communication terminal STA in LLR Report. Conversely, in a case where the coefficient of variance is lower than the threshold value, the access point AP notifies of information regarding a log-likelihood ratio of the corresponding communication terminal STA in LLR Report.

(b2) In a case where an average value of absolute values of log-likelihood ratios is greater than the threshold value for the log-likelihood ratio for the communication terminal STA indicated in each User Info subfield, the access point AP notified of the frame notifies of information regarding a log-likelihood ratio of the corresponding communication terminal STA in LLR Report. Conversely, in a case where the average value is lower than the threshold value, the access point AP does not need to notify of a log-likelihood ratio of the corresponding communication terminal STA in LLR Report.

The threshold value described above may be determined on the basis of the log-likelihood ratio in the access point AP notifying of the frame, and may be determined by, for example, a coefficient of variance with respect to magnitude of the log-likelihood ratio. Note that the Quantization Granularity REQ may be defined for every communication terminal STA indicated in each User Info subfield.

The LLR Combining Soliciting Feedback element includes fields of Element ID, Length, and Soliciting CW User.

The Element ID includes information indicating that the element is the LLR Combining Soliciting Feedback element. The Length includes information indicating a bit length or an octet length of the element.

The Soliciting CW User includes information indicating an LLR to be a notification request target for every communication terminal STA that is a notification request target of the LLR. Here, the number of fields of the Soliciting CW User and the number of fields of the User Info in the LLR Combining Feedback Control element may be matched, and a k-th Soliciting CW User (hereinafter, described as Soliciting CW User #k) may be information for the communication terminal STA indicated by the STA IDₖ in the User Info #k in the LLR Combining Feedback Control element.

Furthermore, the Soliciting CW User #k includes subfields of Length and CW Bitmap. The Length includes information indicating a bit length or an octet length of the subfield. The CW Bitmap includes information indicating a range of a log-likelihood ratio of the communication terminal STA indicated by the STA IDₖ to be requested.

Specific examples of information inserted into the frame may be as follows. Hereinafter, a case is assumed in which a plurality of communication terminals STA simultaneously performs transmission to the access points AP1 and AP2 in UL Transmission. At this time, the access point AP1 can estimate the number N_{CW} of CWs constituting the Data transmitted by each communication terminal STA in UL Transmission, on the basis of: a PPDU Length in a frame whose notification has been provided in LC Trigger executed by the access point AP1 immediately before UL Transmission; and information indicated in the MCS subfield in the EHT Header B in the data unit whose notification is provided in UL Transmission.

Here, when N_{CW}=20 is set, in a case where the access point AP1 requests the access point AP2 for four CWs of #4, #5 , #7, and #10 among the CWs of the Data transmitted by the k-th STA, information indicating “4” is included in the CW Number Start, and information indicating “10” is included in the CW Number End. At this time, the CW Bitmap in the Soliciting CW User #k is expressed by 7 bits that can identify each integer number from #4 to #10, and “1001011” is stored in the CW Bitmap. Here, the lower n-th bit indicates the presence or absence of a request for the CW #(n+3), and indicates a notification request for the CW in a case where the corresponding bit is “1”. Note that, in a case where the CW Bitmap length is determined in advance, it suffices that either the CW Number Start or the CW Number End is present. For example, in a case where the CW Bitmap length is a fixed length of 10 bits, the CW Number End may not be present, and “0001001011” may be stored in the CW Bitmap.

(S24: LLR Report)

The access point AP2 subjected to LLR Report Trigger executes information notification (LLR Report), to the access point AP1, regarding the LLR of the data from the communication terminal STAs received by the access point AP2 (S24 in FIG. 3).

Note that LLR Report Trigger may not be executed, and LLR Report may be executed from the access point AP2 to the access point AP1 after a certain period of time elapses after data is received from the communication terminal STAs.

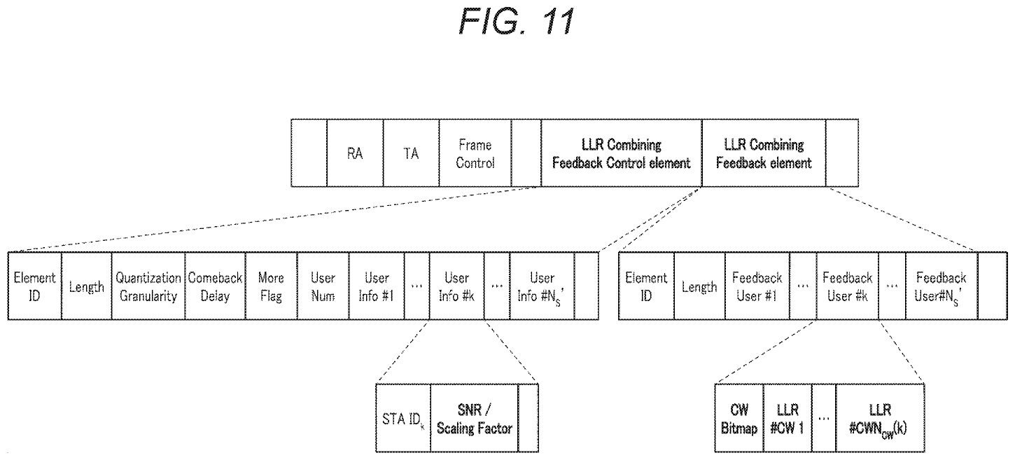

FIG. 11 illustrates a configuration example of a frame whose notification is provided in LLR Report.

This frame includes RA, TA, Frame Control, LLR Combining Feedback Control element, and LLR Combining Feedback element. However, the components of the frame are not limited to these.

The RA and the TA respectively include information indicating a destination terminal and information indicating a transmission source terminal. The Frame Control includes information indicating that the frame is a frame whose notification is provided in LLR Report.

The LLR Combining Feedback Control element includes information regarding the subsequent LLR Combining Feedback element. The LLR Combining Feedback element includes information regarding an LLR notified from the access point AP2 to the access point AP1.

However, the Frame Control does not need to include information indicating, by the Frame Control alone, that the frame is a frame whose notification is provided in LLR Report, but may include information indicating that the frame is a frame whose notification is provided in LLR Report together with information indicated in other fields.

The LLR Combining Feedback Control element includes fields of Element ID, Length, Quantization Granularity, Comeback delay, More Flag, User Num, and User Info.

The Element ID includes information indicating that the element is the LLR Combining Feedback Control element. The Length includes information indicating a bit length or an octet length of the element.

The Quantization Granularity includes information indicating a resolution of a log-likelihood ratio included in the subsequent LLR Combining Feedback element.

The Comeback delay includes information as follows. That is, in a case where the access point AP2 subjected to LLR Report Trigger cannot start notification of information included in the LLR Combining Feedback element within a determined time (for example, a short inter frame space (SIFS) of Document 1 described above) after execution of LLR Report Trigger due to an increase in computation time or the like, the Comeback delay includes a time until the LLR Combining Feedback element can be notified. At this time, the LLR Combining Feedback element does not need to be present.

Conversely, in a case where notification of information included in the LLR Combining Feedback element can be started within a determined time after LLR Report Trigger is executed, the Comeback delay includes information indicating that the notification can be made in the field, together with the LLR Combining Feedback element.

The More Flag includes information indicating that fragmentation is performed in a case where the element or the subsequent LLR Combining Feedback frame is fragmented and information indicating the number of fragmented frames not transmitted.

The User Num includes information indicating the number of fields of subsequent User Info and the number of fields of Feedback User in the subsequent LLR Combining Feedback element. Furthermore, User Info #k which is a k-th User Info field includes subfields of STA IDₖ and SNR/Scaling Factor.

The STA IDₖ includes information indicating the communication terminal STA to be a notification target of the field. The SNR/Scaling Factor includes information regarding a normalization coefficient of the LLR whose notification is provided in the subsequent LLR Combining Feedback element.

The LLR Combining Feedback element includes fields of Element ID, Length, and Feedback User.

The Element ID includes information indicating that the element is the LLR Combining Feedback element. The Length includes information indicating a bit length or an octet length of the element. The Feedback User includes information regarding an LLR of data received by the access point AP2 from the communication terminal STA, and a k-th Feedback User (hereinafter, described as Feedback User #k) includes information from a k-th communication terminal STA.

Furthermore, the Feedback User #k includes subfields of CW Bitmap and LLR #CW. The CW Bitmap includes information indicating the number of the CW whose notification is provided in the subfield. The LLR #CW includes information (likelihood information) regarding a log-likelihood ratio of each CW, and there are N_{CW}(k) pieces of subfield, such as LLR #CW1 to LLR #CWN_{CW}(k) as illustrated in FIG. 11. Note that the information included in the Feedback User #k may be information about the communication terminal STA indicated by the STA IDₖ included in the User Info #k.

Hereinafter, a specific example of information included in the frame will be described. Note that, hereinafter, any given LLR #CW subfield is referred to as LLR #CW m.

In UL Transmission, the access point AP2 that has received data from a certain communication terminal STA calculates information (hereinafter, described as L) regarding a log-likelihood ratio of any bit according to the following Equation (5).

$$[ Formula 5 ]$$

$$L = {\sum }_{{x}_{i} ∈ {X}_{1}^{( m )}} {\vert y - {x}_{i} \vert}^{2} - {\sum }_{{x}_{j} ∈ {X}_{0}^{( m )}} {\vert y - {x}_{j} \vert}^{2} \qquad ( 5 )$$

Note that, in Equation (5), y represents a complex reception symbol after channel equalization, X((m);1) is a subset of a transmission symbol candidate point whose m-th bit is 1 in the complex reception symbol, and similarly, X((m);0) represents a subset of a transmission symbol candidate point whose m-th bit is 0 in the complex reception symbol. Note that L is physically antilogarithm of the log-likelihood ratio.

Furthermore, in Equation (5), a way of determining the subset may be determined in accordance with information indicated in the LLR Algorithm field in the frame whose notification has been provided in LLR Report Trigger executed immediately before.

For example, in a case where a transmission symbol is of quadrature phase shift keying (QPSK) modulation, there are four transmission symbol candidate points. If the LLR Algorithm indicates that the log-likelihood ratio is calculated by comparison with all the transmission symbol candidate points, X((m);1) indicates a set of two different transmission symbol candidate points whose corresponding bit is 1, while X((m);0) indicates a set of two different transmission symbol candidate points whose corresponding bit is 0.

Furthermore, if the LLR Algorithm indicates that the log-likelihood ratio is calculated using only a symbol having a shortest distance of a complex planar shape for each of the symbol whose m-th bit is 0 and the symbol whose m-th bit is 1 with respect to the complex reception symbol, X((m);1) and X((m);0) each have only one different transmission symbol candidate point as an element.

At this time, assuming that the Quantization Granularity has an N_{b} bit length, the LLR #CW m includes information indicating the following value L (a wavy line (˜) is written above L) as shown in the following Equation (6) by using a certain normalization coefficient K. Here, |x| represents a maximum integer not exceeding x.

$$[ Formula 6 ]$$

$$\tilde{L} = \{ \begin{matrix}1 - \frac{1}{{2}^{( {N}_{b} - 1 )}} & 1 \leq \frac{L}{K} \\ {2}^{⌊ {log}_{2} ( \frac{L}{K} ) ⌋} & - 1 < \frac{L}{K} < 1 \\ - 1 & \frac{L}{K} \leq - 1\end{matrix} \qquad ( 6 )$$

Furthermore, in a case where a signal-to-noise ratio (SNR) in a propagation path between the communication terminal STA and the access point AP2 is γ [dB] and a bit length of SNR/Scaling Factor is N_{b}′, the SNR/Scaling Factor includes information indicating a value γ (a wavy line (˜) is written above γ) expressed by the following Equation (7).

$$[ Formula 7 ]$$

$$\tilde{γ} = \cdot \{ \begin{matrix}{Th}_{Max} & {Th}_{Max} \leq {γ}^{′} \cdot \\ {Th}_{min} + ⌊ \frac{{γ}^{′} - {Th}_{min}}{Δ t} ⌋ Δ t & \cdot \cdot {Th}_{min} < {γ}^{′} < {Th}_{Max} \\ {Th}_{min} & {γ}^{′} \leq {Th}_{min}\end{matrix} \qquad ( 7 )$$

Note that, γ′ and Δt are assumed to satisfy the following Equations (8) and (9).

$$[ Formula 8 ]$$

$${γ}^{′} = \cdot γ + 10 {log}_{10} K \qquad ( 8 )$$

$$[ Formula 9 ]$$

$$Δ t = \frac{{Th}_{Max} - {Th}_{min}}{{2}^{{N}_{b}^{′}} - 1} \qquad ( 9 )$$

Note that, in Equations (8) and (9), Thₘᵢₙ and Th_{Max} may simply be values determined between the access point AP1 and the access point AP2 in advance, for example, N_{b}′ may be set to 8 [bits], Thₘᵢₙ may be set to −10 [dB], and Th_{Max} may be set to 53.75 [dB], and γ (a wavy line (˜) is written above γ) may be expressed in units of 0.25 dB.

Furthermore, for the CW whose notification has been requested in the CW Start Num, the CW End Num, and the CW bitmap in the frame whose notification has been provided in LLR Report Trigger executed immediately before LLR Report, the same bit length as the bit length indicated by the CW bitmap in the frame whose notification has been provided in LLR Report Trigger may be used to represent the CW bitmap in the Feedback User.

That is, in a case where the CW requested in LLR Report Trigger is notified in LLR Report, a value of the CW Bitmap in the frame whose notification has been provided in LLR Report Trigger matches a value of the CW Bitmap in the frame whose notification is provided in LLR Report. However, it is assumed that the communication terminals STA indicated by the CW Bitmap of both are the same.

Note that, in some cases, a threshold value for determining a log-likelihood ratio to be notified is included in the Quantization Granularity REQ in the frame whose notification is provided in LLR Report Trigger. At this time, in a case where there is a log-likelihood ratio for which notification is not made by the access point AP2 to the access point AP1 on the basis of the threshold value, it is not possible to obtain all the log-likelihood ratios for the communication terminals STA for which the access point AP1 requests the access point AP2 for notification of the log-likelihood ratio in LLR Report Trigger. In this case, after LLR Report is executed, the access point AP1 may request the corresponding communication terminal STA to retransmit the target data of the log-likelihood ratio not obtained in LLR Report.

(S25: LLR Combining)

The sharing AP (AP1) subjected to LLR Report executes combining (LLR Combining) of log-likelihood ratios for data from the communication terminal STAs received in UL Transmission, on the basis of information notified from the shared AP (AP2) (S25 in FIG. 3).

Hereinafter, a specific example of LLR Combining will be described. Here, a log-likelihood ratio of a reception signal observed in a k-th AP with respect to an n-th bit of an m-th symbol in an L-th CW transmitted from a certain communication terminal STA is assumed to be λ((k);(L, m, n)), which can be expressed by the following Equation (10).

$$[ Formula 10 ]$$

$${λ}_{( L , m , n )}^{( k )} = {\sum }_{{x}_{i} ∈ {X}_{1}^{( m )}}^{\cdot } \frac{{\vert {y}_{( L , m )}^{( k )} - {x}_{i}^{( k )} \vert}^{2}}{{γ}_{k}^{2}} - {\sum }_{{x}_{j} ∈ {X}_{0}^{( m )}}^{\cdot } \frac{{\vert {y}_{( L , m )}^{( k )} - {x}_{j}^{( l )} \vert}^{2}}{{γ}_{k}^{2}} \qquad ( 10 )$$

Generally, a log-likelihood ratio notified in LLR Report is quantized in order to be represented by a finite bit length, and the estimated log-likelihood ratio λ((k);(L, m, n)) (a wavy line (˜) is written above λ) obtained by adding quantization noise to a log-likelihood ratio observed in the shared AP is obtained by the sharing AP. In a case where LLR Report is executed immediately before, the estimated log-likelihood ratio λ((k);(L, m, n)) (a wavy line (˜) is written above λ) can be obtained from information included in the Feedback User corresponding to the User Info in a frame whose notification has been provided, as in the following Equation (11).

$$[ Formula 11 ]$$

$${\tilde{λ}}_{( L , m , n )}^{( k )} = \frac{\tilde{L}}{{10}^{( \frac{\tilde{γ}}{10} )}} \qquad ( 11 )$$

Note that, in Equation (11), it is assumed that γ (a wavy line (˜) is written above γ) [dB] is a normalization coefficient obtained from information indicated in the SNR/Scaling Factor in the User Info, and L (a wavy line (˜) is written above L) is normalization antilogarithm of a log-likelihood ratio obtained from information indicated by the LLR #CW subfield in the Feedback User. At this time, in LLR Combining executed by the access point AP1, a combined log-likelihood ratio Δ_{(L, k, n)} (a wavy line (˜) is written above λ) expressed by the following Equation (12) is calculated.

$$[ Formula 12 ]$$

$${\tilde{λ}}_{( L , k , n )} = {λ}_{( L , m , n )} + {\sum }_{k ∈ K ( L )} {\tilde{λ}}_{( L , m , n )}^{( k )} \qquad ( 12 )$$

Note that, in Equation (12), K(L) is a set of shared APs for which log-likelihood ratios to be a combining target in the L-th CW are calculated, and λ_{(L, m, n)} represents a log-likelihood ratio calculated by the sharing AP that is an execution entity of LLR Combining. That is, a combined log-likelihood ratio for the L-th CW is obtained by combining the log-likelihood ratio calculated by the execution entity of LLR Combining and the log-likelihood ratio notified from the shared AP included in the set of K(L).

Note that the sequence of FIG. 3 illustrates a case where Capabilities Exchange (S11) is executed from the access point AP1, but Capabilities Exchange may be executed first from the access point AP2, and the order of communication in Capabilities Exchange does not matter. This similarly applies between the access point AP1 and the communication terminal STAs. Although not illustrated in the figure, Capabilities Exchange may also be executed between the access point AP2 and the communication terminal STAs.

Furthermore, similarly, the sequence of FIG. 3 illustrates a case where Link State Report (S14) is executed after the access point AP1 executes Link State Request (S13) to the access point AP2, but Link State Report may be executed from the access point AP1 to the access point AP2 after Link State Request is executed from the access point AP2 to the access point AP1.

The sequence in FIG. 3 may be partially omitted as necessary, and the order may not be as illustrated in the figure. For example, BSRP Trigger (S15) does not need to be present, and BSRP Trigger (S15) and the BSRP (S16) may be executed before Link State Request (S13) and Link State Report (S14).

Furthermore, while LLR Report Trigger (S23) is request notification for execution of LLR Report (S24), LLR Report Trigger (S23) does not need to be executed if it is understood that LLR Report (S24) is executed after the elapse of a certain period of time known from each other after UL Transmission (S22) is executed.

Ack illustrated in FIG. 3 represents notification of information indicating a reception result for information notification executed immediately before. The notification method here may be executed by Ack or Block Ack defined in Document 1 described above. Note that some Acks do not need to be executed.

Furthermore, the sequence of FIG. 3 illustrates that LLR Combining (S25) for executing the log-likelihood ratio combining processing is executed by the access point AP1, but LLR Combining may be executed on the receiving terminal side in LLR Report (S24) which is information notification related to the log-likelihood ratio. That is, the sequence of FIG. 3 illustrates that LLR Report (S24) is executed from the access point AP2 to the access point AP1, but the execution entity of LLR Combining (S25) is to be the access point AP2 in a case where LLR Report (S24) is executed from the access point AP1 to the access point AP2.

Although not illustrated in FIG. 3, this is a case where the access point AP2 executes LLR Combining (S25) within a period in which a transmission right obtained by the access point AP1 is valid. At this time, LLR Report Trigger (S23), which is an execution request for LLR Report (S24), is executed from the access point AP2 to the access point AP1, and LLR Report (S24) is executed from the access point AP1 to the access point AP2.

Note that, regarding the description regarding the transmission right, in the access point AP1 which is the execution entity of LLR Combining Setup Request (S18), the access point AP1 may acquire the transmission right in advance and execute from LLR Combining Setup Request (S18) to at least UL Transmission (S22) within a time period in which the acquired transmission right is valid. Subsequent LLR Report Trigger (S23) to the Ack may be executed within a time period in which the transmission right acquired again by the access point AP1 or the access point AP2 is valid, or may be executed within a time period in which the transmission right acquired immediately before execution of LLR Combining Setup Request (S18) is valid.

### 2. Second Embodiment

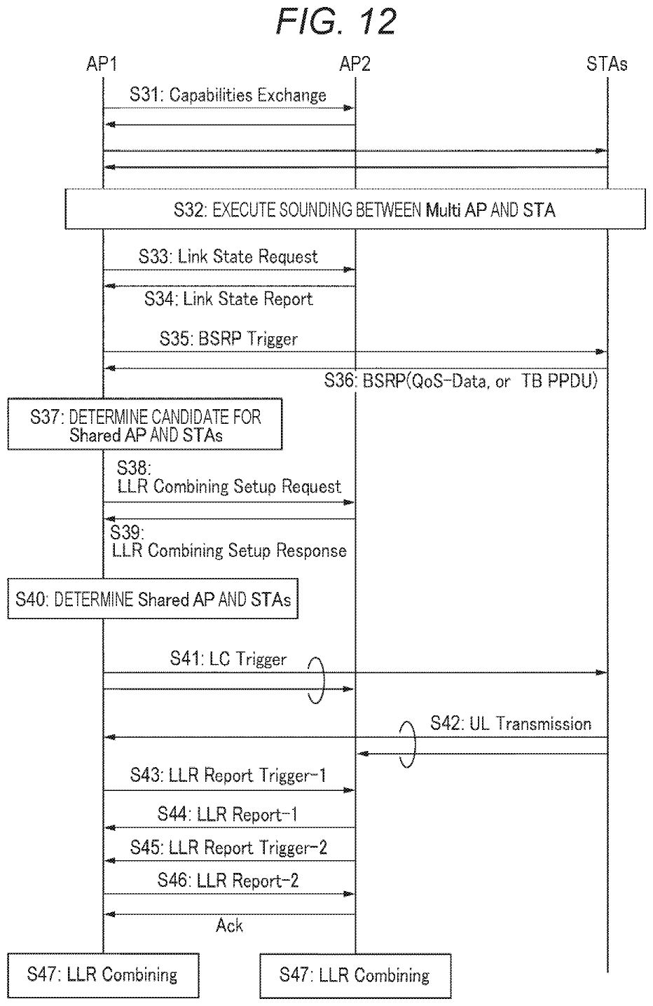

FIG. 12 illustrates a second example of an entire sequence of the present technology.

The sequence of FIG. 12 illustrates a case where LLR Report is executed between an access point AP1 and an access point AP2 as compared with the sequence of FIG. 3. Also in FIG. 12, it is assumed that there are two access points AP of AP1 and AP2 constituting a multi AP, and there is a communication terminal STAs of a plurality of pieces.

In the sequence of FIG. 12, Capabilities Exchange (S31), sounding between the Multi AP and the STA (S32), Link State Request (S33), Link State Report (S34), BSRP Trigger (S35), BSRP (S36), and candidate determination of a Shared AP and the STAs (S37) are similar to S11 to S17 in the sequence of FIG. 3, and an operation of each device and a frame configuration to be notified are also similar. Hereinafter, in the sequence of FIG. 12, points different from the sequence of FIG. 3 will be described.

(S38: LLR Combining Setup Request)

Prior to execution of LLR Combining, in uplink transmission of the communication terminal STAs, the access point AP1 that has determined candidates for the shared AP for joint operation and the communication terminal STAs for transmission executes an execution request for LLR Combining (LLR Combining Setup Request) to the shared AP (S38 in FIG. 12). Here, it is assumed that the access point AP1 executes LLR Combining Setup Request after acquiring a transmission right, and the access point AP2 has been selected as a candidate for the shared AP.

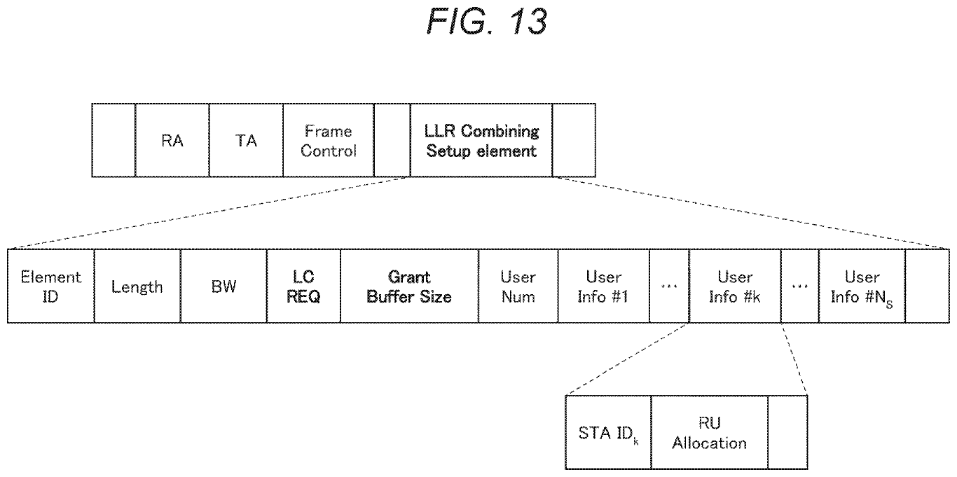

FIG. 13 illustrates a configuration example of a frame whose notification is provided in LLR Combining Setup Request.

This frame includes RA, TA, Frame Control, and LLR Combining Setup element. However, the components of the frame are not limited to these.

The RA and the TA respectively include information indicating a destination terminal and information indicating a transmission source terminal. For example, in the RA and the TA, a MAC address specific to the terminal may be indicated, but identification information specific to the multi AP may be indicated in a case where a destination is a plurality of access points AP constituting the multi AP.

The Frame Control includes information indicating that the frame is a frame whose notification is provided in LLR Combining Setup Request.

The LLR Combining Setup element includes information regarding an execution request for LLR Combining. The LLR Combining Setup element internally includes at least one of fields of Element ID, Length, BW, LC REQ, Grant Buffer Size, User Num, and User Info #1 to #N_{S}.

The Element ID includes information indicating that the element is the LLR Combining Setup element. The Length includes information regarding a bit length of the LLR Combining Setup element.

The BW includes information indicating, by the terminal notifying of the frame to the destination terminal, “a frequency band to be a calculation target of a log-likelihood ratio for a signal transmitted from the communication terminal STAs in UL Transmission (S42 in FIG. 12) requested to the destination terminal. The LC REQ includes information indicating an execution request for LLR Combining.

The Grant Buffer Size includes information indicating a maximum amount of information regarding a log-likelihood ratio that can be notified by the access point AP1 notifying of the frame to the shared AP, in subsequent LLR Report. The User Num includes information indicating the number of fields N_{S} of the subsequent User Info.

Each of User Info #1 to #N_{S} includes information regarding the communication terminal STA that is an execution target candidate of LLR Combining in UL Transmission (S42 in FIG. 12). In particular, each User Info indicates information for different communication terminals STA, and includes subfields of STA IDₖ and RU Allocation.

The STA IDₖ includes information indicating the communication terminal STA as a target of information indicated in the User Info #k. The RU Allocation includes information indicating, by the terminal transmitting the frame, a requested range of a frequency resource that is a target of a log likelihood to be notified to the terminal after UL Transmission, in information notification (LLR Report) regarding the log-likelihood ratio.

Note that the information indicated by the STA IDₖ in the frame may be an association ID (AID) of IEEE 802.11 as an information format. Furthermore, the RU Allocation may indicate a frequency resource together with information included in the BW field.

(S39: LLR Combining Setup Response)

The access point AP2 subjected to LLR Combining Request executes information notification (LLR Combining Setup Response) to the access point AP1 (S39 in FIG. 12). This information notification includes whether or not joint operation in LLR Combining is possible, an information amount of information regarding a log-likelihood ratio that can be temporarily stored in the access point AP2, and notification of information regarding “the communication terminal STA that is an execution target candidate of LLR Combining in UL Transmission” requested by the access point AP2.

A configuration example of the frame whose notification is provided in LLR Combining Setup Response is similar to the configuration example illustrated in FIG. 6, but the following points are different.

That is, User Info #1 to #N_{S}′ individually include information regarding the communication terminal STA targeted for the following (c1) and (c2).

(c1) a candidate of the communication terminal STA to be a notification target of the access point AP2 in subsequent LLR Report-1, in the communication terminals STA indicated by the User Info in the frame whose notification has been provided in LLR Combining Setup Request executed immediately before (c2) a candidate of the communication terminal STA that is a target of information regarding the log-likelihood ratio to be notified from the access point AP1 to the access point AP2 in subsequent LLR Report-2 by the access point AP2 to the access point AP1

However, in a case where all the communication terminals STA of (c1) match the communication terminal STA indicated by the User Info in the frame whose notification has been provided in LLR Combining Setup Request executed immediately before, the information indicating (c1) does not need to be included in the User Info. At this time, the LC Grant may include information indicating that the access point AP2 can execute LLR Report-1 for all the communication terminals STA indicated by the User Info in the frame whose notification has been provided in LLR Combining Setup Request executed immediately before.

(S41: LC Trigger)

The access point AP1 that has determined the shared AP (AP2) for joint operation in LLR Combining and the communication terminal STAs for transmission executes information notification (LC Trigger) prompting execution of UL Transmission prior to execution of LLR Combining, to the communication terminal STAs and the shared AP (AP2) (S41 in FIG. 12). The communication terminal STAs subjected to LC Trigger transmits data to the access point AP1 or to both the access points AP1 and AP2.

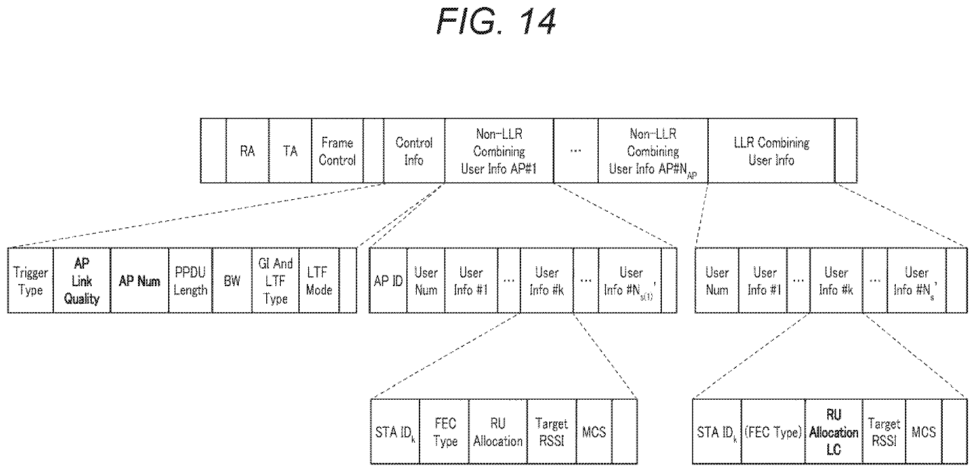

FIG. 14 illustrates a configuration example of a frame whose notification is provided in LC Trigger.

This frame includes RA, TA, Frame Control, Control Info, Non-LLR Combining User Info, and LLR Combining User Info. However, the components of the frame are not limited to these.

The Control Info includes at least one of subfields of Trigger Type, AP Link Quality, AP Num, PPDU Length, BW, GI And LTF Type, LTF Mode.

The Trigger Type includes information indicating that the frame is a frame whose notification is provided in LC Trigger, by being used together with information included in the Frame Control. The AP Link Quality includes information indicating link quality between the access point AP1 and the access point AP2.

The AP Num includes information indicating N_{AP} which is the number of pieces of the Non-LLR Combining User Info. The PPDU Length includes information regarding a length of data (PHY Protocol Data Unit (PPDU)) transmitted by the communication terminal STA that performs transmission in UL Transmission. The BW includes information indicating a frequency band to be used by the communication terminal STA that performs transmission in UL Transmission. However, the BW may include information indicating a frequency resource to be allocated to each communication terminal STA, by being used together with RU Allocation in the subsequent User Info.

The GI And LTF Type includes information indicating a guard interval (GI) length to be used by the communication terminal STA that performs transmission in UL Transmission and indicating a known sequence (a long training field: LTF) length for channel estimation and frequency synchronization. The LTF Mode includes information indicating whether or not a known sequence is made orthogonal in a code domain between the communication terminals STA in UL Transmission.

A plurality of pieces of the Non-LLR Combining User Info may be present as illustrated in FIG. 14. In FIG. 14, there are N_{AP} pieces of the Non-LLR Combining User Info.

Each piece of Non-LLR Combining User Info includes information indicating the access point AP as a destination, a frequency resource, a coding scheme, and the like for each communication terminal STA that performs transmission in the subsequent UL Transmission, and information is determined for every access point AP as a destination. The Non-LLR Combining User Info includes at least one of subfields of AP ID, User Num, and User Info.

The AP ID includes information uniquely identifying the access point AP. The User Num includes information indicating the number of fields N_{S}′ of the subsequent User Info included in the Non-LLR Combining User Info. User Info #1 to #N_{S}′ include information regarding parameters to be used in UL Transmission for each communication terminal STA to be permitted for transmission in UL Transmission.

Each User Info field internally includes at least one of subfields of STA IDₖ, FEC Type, RU Allocation, Target RSSI, and MCS. Here, any one piece of the User Info is set as User Info #k.

The STA IDₖ includes information uniquely identifying the communication terminal STA. The FEC Type includes information regarding an error correction code (forward error check (FEC)) to be used in UL Transmission. The RU Allocation includes information indicating a frequency resource to be used in UL Transmission by the communication terminal STA indicated by the STA IDₖ. However, in the RU Allocation, the frequency resource to be used by the communication terminal STA may be interpreted together with information indicated by the BW in the Control Info.

The Target RSSI includes information indicating a target value of reception power at the access point AP for which the communication terminal STA indicated by the STA IDₖ is to be a destination in UL Transmission. However, the Target RSSI may be information indicating a target value of reception power observed in the access point AP1, and the communication terminal STA notified of the frame determines transmission power in UL Transmission so as to obtain the target value of the reception power indicated in the Target RSSI on the basis of the reception power in the received frame. Note that, although not illustrated in the figure, information indicating a transmission power value of the frame may be included in another field.

The MCS includes information regarding a coding scheme to be used by the communication terminal STA indicated by the STA IDₖ in UL Transmission.

The LLR Combining User Info similarly includes information indicating a frequency resource, a coding scheme, and the like regarding the communication terminal STA to be an execution target of LLR Combining. The LLR Combining User Info includes at least one of fields of User Num and User Info #1 to #N_{S}′.

The User Num includes information indicating a number of fields N_{S}′ of the subsequent User Info. The User Info #1 to #N_{S}′ include information regarding parameters to be used in UL Transmission for each communication terminal STA to be permitted for transmission in UL Transmission. Note that, in a case where the SU/MU includes information indicating that only one communication terminal STA performs transmission in UL Transmission, the number pieces of User Info is one, and User Num does not need to be present.

Each User Info field internally includes at least one of subfields of STA IDₖ, FEC Type, RU Allocation LC, Target RSSI, or MCS, but is basically similar to each field of the User Info of the Non-LLR Combining User Info. However, the RU Allocation LC includes information indicating a frequency resource to be a target of LLR Combining, among frequency resources to be used in UL Transmission by the communication terminal STA indicated by the STA IDₖ.

Note that whether to include the FEC Type is freely determined. Furthermore, the Target RSSI may be information indicating a target value of reception power observed in the access point AP1, and the communication terminal STA notified of the frame determines transmission power in UL Transmission so as to obtain the target value of the reception power indicated in the Target RSSI on the basis of the reception power in the received frame. Note that, although not illustrated in the figure, information indicating a transmission power value of the frame may be included in another field.

(S44: LLR Report-1, S45: LLR Report Trigger-2)

The access point AP2 subjected to LLR Report Trigger-1 notifies (LLR Report-1) the access point AP1 of information regarding a log-likelihood ratio of a reception signal from the communication terminal STAs in UL Transmission (S44 in FIG. 12).

A configuration example of the frame whose notification is provided in LLR Report-1 is similar to the configuration example of FIG. 11 in the sequence of FIG. 3. At the same time, LLR Report Trigger-2 may also be executed together (S45 in FIG. 12). LLR Report Trigger-2 is similar to LLR Report Trigger (S23 in FIG. 3) in the sequence of FIG. 3.

Note that, although not described in the sequence of FIG. 12, in a case where LLR Report Trigger-2 is not simultaneously executed together, Ack that is an acknowledgment of LLR Report-1 may be notified from the access point AP1 to the access point AP2. In this case, the access point AP2 notified of the Ack may execute LLR Report Trigger-2 for the access point AP1.

(S46: LLR Report-2)

The access point AP1 subjected to LLR Report Trigger-2 notifies (LLR Report-2) the access point AP2 of information regarding a log-likelihood ratio of a reception signal from the communication terminal STAs in UL Transmission (S46 in FIG. 3).

A configuration example of the frame whose notification is provided in LLR Report-2 is similar to the configuration example of FIG. 11 in the sequence of FIG. 3. However, in a case where LLR Report-1 is executed simultaneously together with LLR Report Trigger-2, the access point AP2 notified of the frame may interpret that LLR Report-1 executed immediately before is received by the access point AP1 without errors.

Note that the sequence of FIG. 12 illustrates a case where Capabilities Exchange (S31) is executed from the access point AP1, but Capabilities Exchange may be executed first from the access point AP2, and the order of communication in Capabilities Exchange does not matter. This similarly applies between the access point AP1 and the communication terminal STAs. Although not illustrated in the figure, Capabilities Exchange may also be executed between the access point AP2 and the communication terminal STAs.

Furthermore, similarly, FIG. 12 illustrates a case where Link State Report (S34) is executed after the access point AP1 executes Link State Request (S33) to the access point AP2, but Link State Report may be executed from the access point AP1 to the access point AP2 after Link State Request is executed from the access point AP2 to the access point AP1.

The sequence in FIG. 12 may be partially omitted as necessary, and the order may not be as illustrated in the figure. For example, BSRP Trigger (S35) does not need to be present, and BSRP Trigger (S35) and the BSRP (S36) may be executed before Link State Request (S33) and Link State Report (S34). Furthermore, LC Trigger (S41) may be executed by the access point AP2 to the access point AP1 and the communication terminal STAs.

Furthermore, while LLR Report Trigger (S43, S45) is request notification for execution of LLR Report, LLR Report Trigger does not need to be executed if it is understood that LLR Report (S44, S46) is executed after the elapse of a certain period of time known from each other after execution of UL Transmission (S42). Furthermore, LLR Report Trigger-2 (S45) and LLR Report-2 (S46) may be executed prior to LLR Report Trigger-1 (S43). At this time, Ack may be executed from the access point AP1 after LLR Report-1 (S44) is executed.

Ack illustrated in FIG. 12 represents notification of information indicating a reception result for information notification executed immediately before. The notification method here may be executed by Ack or Block Ack defined in Document 1 described above. Note that some Acks do not need to be executed.

### 3. Third Embodiment

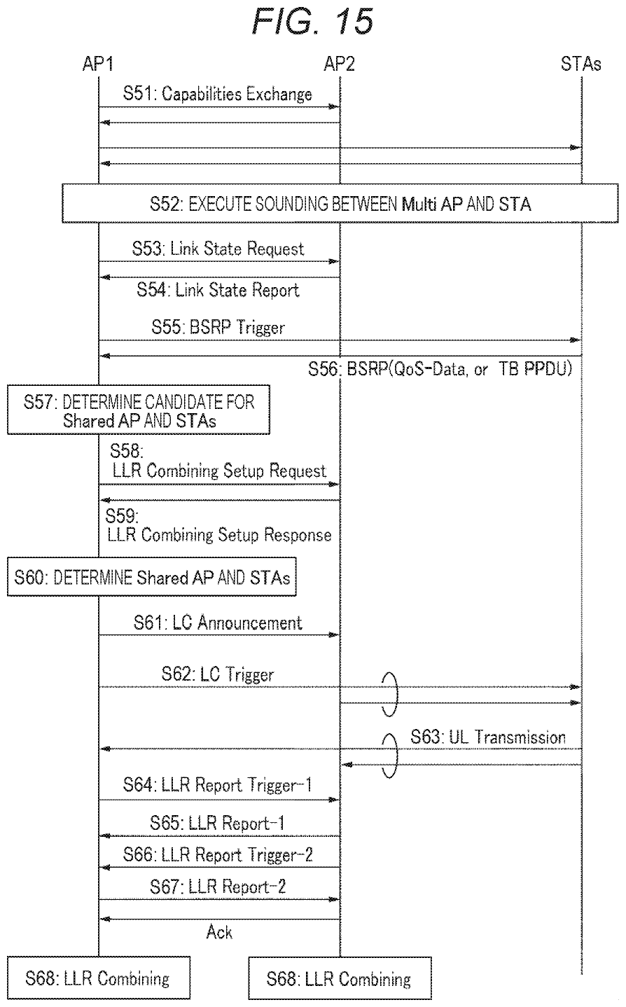

FIG. 15 is a view illustrating a third example of an entire sequence of the present technology.

The sequence in FIG. 15 is the same in that LLR Report is executed between an access point AP1 and an access point AP2 similarly to the sequence in FIG. 12, but is different in that LC Trigger is executed from the access point AP1 and the access point AP2 at the same time, and LC Announcement is executed immediately before LC Trigger.

Although details will be described later, by simultaneously estimating reception power in the access point AP1 and the access point AP2 by using LC Trigger in the communication terminal STAs, transmission can be performed so as to obtain desired reception power in the access point AP1 and the access point AP2 in UL Transmission.

In FIG. 15, it is assumed that there are two access points AP of AP1 and AP2 constituting a multi AP, and there is a communication terminal STAs of a plurality of pieces. The sequence of FIG. 15 is basically similar to the sequence of FIG. 12, but differences from the sequence of FIG. 12 will be described below. In particular, LC Announcement and LC Trigger, which are difference points, will be mentioned. LC Trigger is executed simultaneously from the access points AP1 and AP2 to the communication terminal STAs.

(S61: LC Announcement)

The access point AP1 that has determined a shared AP (AP2) for joint operation in LLR Combining and the communication terminal STAs for transmission executes information notification (LC Announcement) for executing notification to the communication terminal STAs in LC Trigger for the access point AP2, prior to execution of LC Trigger (S61 in FIG. 15).

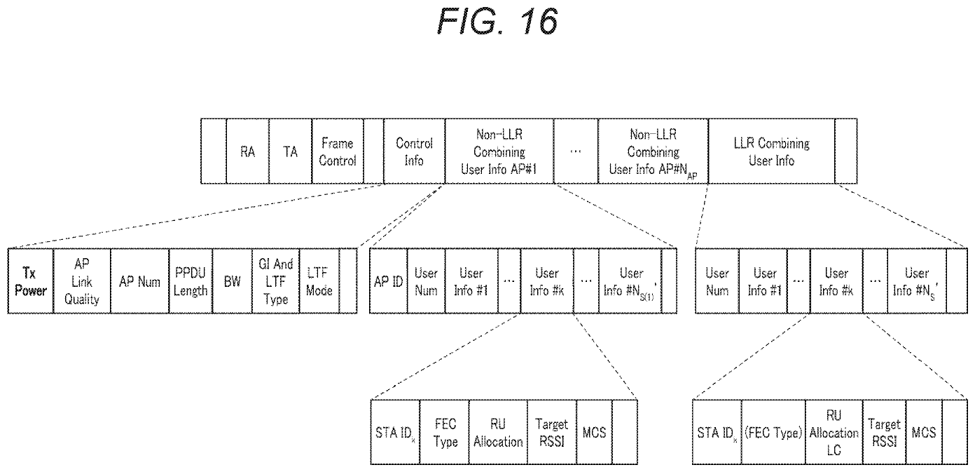

FIG. 16 illustrates a configuration example of a frame whose notification is provided in LC Announcement.

This frame includes RA, TA, Frame Control, Control Info, Non-LLR Combining User Info, and LLR Combining User Info. However, the components of the frame are not limited to these.

Each field to be notified is similar to that of the configuration example of the frame whose notification is provided in LC Trigger illustrated in FIG. 14, and in particular, the Non-LLR Combining User Info and the LLR Combining User Info indicate information similar to information to be notified in subsequent LC Trigger. In the following, FIG. 16 mentions only difference points from the configuration example of the frame whose notification is provided in LC Trigger of FIG. 14.

Tx Power in the Control Info includes information indicating transmission power at a time of transmitting the frame in LC Trigger immediately after. Note that, in a case where there are three or more access points AP that notify of LC Trigger, that is, in a case where there is a plurality of access points AP as a destination of the frame, the Tx Power may include information indicating transmission power to each access point AP.

(S62: LC Trigger)

The access points AP1 and AP2 execute, to the communication terminal STAs, information notification (LC Trigger) prompting execution of UL Transmission prior to execution of LLR Combining (S62 in FIG. 15). The communication terminal STAs subjected to LC Trigger transmits data to both the access points AP1 and AP2.

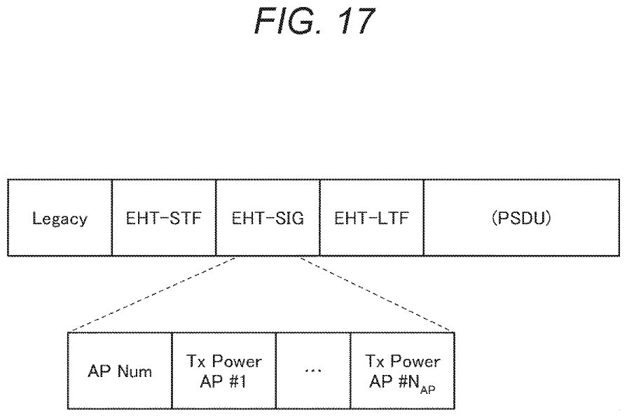

FIG. 17 illustrates a configuration example of a data unit whose notification is provided in LC Trigger.

The data unit includes Legacy, EHT-STF, EHT-SIG, EHT-LTF, and PHY Service Data Unit (PSDU).

The Legacy includes a known sequence for executing time synchronization, frequency synchronization, and channel estimation for demodulation in reception of the data unit.

Similarly, the EHT-short training field (STF) also includes a known sequence for executing time synchronization and frequency synchronization, but may be generated for, as a target, a frequency width different from that of the Legacy. For example, in a case where the data unit is generated using a 80 MHz width, a similar known sequence is used in units of 20 MHz widths in the Legacy, but one known sequence may be used in 80 MHz in the EHT-STF. At this time, the frequency width used in the Legacy may be determined in advance between the access point AP and the communication terminal STA.

The Extremely High Throughput (EHT)-Signal (SIG) includes subfields of AP Num and Tx Power AP. However, the components of the EHT-SIG are not limited to these.

The AP Num includes information indicating the number of subfields of the subsequent Tx Power. The Tx Power AP includes information indicating the access point AP that transmits the data unit and information indicating transmission power applied at a time of transmitting the data unit.

The EHT-long training field (LTF) includes a known sequence for channel estimation. The known sequence may be orthogonal between the access points AP that transmit the data unit, and for example, the known sequence may be generated according to a Hadamard matrix. The PSDU includes the frame illustrated in FIG. 14.

Note that, in the sequence of FIG. 15, similarly to the sequences of FIGS. 3 and 12, a part thereof may be omitted as necessary, and the order may not be as illustrated in the figure.

In the communication device 10 configured to execute such processing as described above, the following processing is executed by at least one control unit out of the control unit 100 and the wireless control unit 110.

That is, in the communication device 10 (for example, the access point AP2), in performing joint reception with a first communication device (for example, the access point AP1) on a reception signal from one or more second communication devices (for example, the communication terminal STAs of a plurality of pieces) first information is generated (for example, a frame including the LLR #CW in FIG. 11) indicating likelihood information of the reception signal for every second communication device, second information is generated (for example, a frame including the LLR Buffer Size of FIG. 4 or the Grant Buffer Size of FIG. 6) regarding an information amount of the first information that can be stored in a storage unit (for example, the storage unit 121 in FIG. 2) that temporarily stores the likelihood information, and the generated first information and second information are transmitted to the first communication device.

In this communication device 10 (for example, the access point AP2), third information is generated (for example, the frame in FIG. 11) including: the number of a codeword (for example, the CW Bitmap in FIG. 11) targeted by the likelihood information indicated by the first information; and a quantum resolution (for example, the Quantization Granularity in FIG. 11) of the likelihood information indicated by the first information, and the generated third information is transmitted to the first communication device. Furthermore, the likelihood information indicated by the first information may be normalized likelihood information, fourth information (a frame including the SNR/Scaling Factor in FIG. 11) indicating a normalization coefficient in the first information may be generated, and the generated fourth information may be transmitted to the first communication device.

In this communication device 10 (for example, the access point AP2), for an execution request (for example, the LC REQ in FIG. 5) for joint reception notified from the first communication device (for example, the access point AP1), fifth information is generated (for example, the frame in FIG. 6) including: information (for example, the LC Grant in FIG. 6) indicating whether or not joint reception is possible; information (for example, the STA ID in FIG. 6) indicating the second communication device in executing the joint reception; information (for example, the LLR Algorithm in FIG. 6) indicating a request scheme related to a calculation scheme of a log-likelihood ratio in the first communication device; and information (for example, the Grant RU Allocation in FIG. 6) indicating a frequency resource to be allocated to the second communication device, and the generated fifth information is transmitted to the first communication device.

In this communication device 10 (for example, the access point AP2), sixth information is generated (for example, the frame in FIG. 10) including: information (for example, the Frame Control in FIG. 10) indicating a notification request for likelihood information for a reception signal from any second communication device to the first communication device after joint reception; information (for example, the CW Number Start and the CW Number End in FIG. 10) indicating a range of likelihood information requested for every second communication device; and information (for example, the Quantization Granularity REQ in FIG. 10) indicating a requested value of a resolution of the likelihood information, and the generated sixth information is transmitted to the first communication device.

In the communication device 10 (for example, the access point AP2), seventh information is generated (for example, the frame in FIG. 14) including: information (for example, the AP Link Quality in FIG. 14) indicating link quality with the first communication device that performs joint reception; information (for example, the AP Num in FIG. 14) indicating the number of first communication devices in the joint reception; and information (for example, the RU Allocation LC in FIG. 14) indicating a frequency resource to be used by the second communication device that is a target of the joint reception in the joint reception, and the generated seventh information is transmitted to the second communication device. Furthermore, in this communication device 10 (for example, the access point AP2), eighth information is generated (for example, the frame in FIG. 4) including: information (for example, the LLR Combining Capability in FIG. 4) indicating whether or not joint reception is possible; and information (for example, the LLR Algorithm in FIG. 4) indicating a calculation algorithm for the likelihood information, and the generated eighth information is transmitted to the first communication device and the second communication device.

Furthermore, in the communication device 10 (for example, the access point AP1), ninth information is generated (for example, the frame in FIG. 5) including: information (for example, the LC REQ in FIG. 5) indicating a request for joint reception to the first communication device in performing the joint reception with the first communication device (for example, the access point AP2) on a reception signal from one or more second communication devices (for example, the communication terminal STAs of a plurality of pieces); information (for example, the LC REQ or the Frame Control in FIG. 5) indicating a notification request for an information amount of the first information that can be stored in the storage unit of the first communication device in the joint reception; and information (for example, the LLR Algorithm REQ in FIG. 5) indicating a request scheme related to a calculation scheme of a log-likelihood ratio in the first communication device, and the generated ninth information is transmitted to the first communication device.

In the communication device 10 (for example, the access point AP1), tenth information is generated (for example, the frame in FIG. 4) including: information (for example, the LLR Combining Capability in FIG. 4) indicating whether or not joint reception is possible; and information (for example, the LLR Algorithm in FIG. 4) indicating a calculation algorithm for the likelihood information, and the generated tenth information is transmitted to the first communication device (for example, the access point AP2) and the second communication device (for example, the communication terminal STA). Furthermore, in this communication device 10 (for example, the access point AP1), eleventh information is generated (for example, the frame in FIG. 7 or 14) including: information (for example, the AP Link Quality in FIG. 7 or 14) indicating link quality with the first communication device that performs joint reception; information (for example, the AP Num in FIG. 14) indicating the number of first communication devices in the joint reception; and information (for example, the RU Allocation LC in FIG. 7 or 14) indicating a frequency resource to be used by the second communication device that is a target of the joint reception in the joint reception, and the eleventh information is transmitted to the first communication device.

Furthermore, in the communication device 10 (for example, the communication terminal STA), twelfth information is generated (for example, a frame including the LC Mode in FIG. 8) indicating that the joint reception is requested to a first communication device in transmitting a transmission signal to, as a destination, a plurality of first communication devices (for example, the access points AP) that operates jointly with each other, and the generated twelfth information is transmitted to the first communication devices.

In this communication device 10 (for example, the communication terminal STA), thirteenth information is generated (for example, the frame in FIG. 8) including: information (for example, the AP Num and AP ID in FIG. 8) indicating the number of first communication devices to be a destination and indicating the first communication devices; and information (for example, the RU in FIG. 8) indicating a frequency resource to be used for every first communication device as a destination, and the generated thirteenth information is transmitted to the first communication devices.

Furthermore, in this communication device 10 (for example, the communication terminal STA), codeword information is individually allocated to a frequency resource to be used for a plurality of first communication devices that operates jointly with each other, and the codeword information allocated to the frequency resource is transmitted. Moreover, in this communication device 10 (for example, the communication terminal STA), fourteenth information is generated (for example, a frame including the LLR Combining Capability in FIG. 4) indicating whether or not transmission signals can be simultaneously transmitted to a plurality of first communication devices capable of executing joint reception, and the generated fourteenth information is transmitted to the first communication devices.

By executing such processing between a plurality of communication devices 10 (for example, the access points AP1 and AP2 and the communication terminal STA), the communication quality can be improved in executing LLR Combining.

Note that the series of processing of the communication device 10 described above can be executed by hardware or software. In a case where the series of processing is executed by software, a program constituting the software is installed in a computer of each device.

The embodiments of the present technology are not limited to the above-described embodiments, and various modifications can be made without departing from the scope of the present technology.

Moreover, each step described in the above-described entire sequence can be executed by one device or can be shared and executed by a plurality of devices. Moreover, in a case where one step includes a plurality of processes, the plurality of processes included in the one step can be executed by one device, and also shared and executed by a plurality of devices.

Note that, in the present specification, the system means a set of a plurality of components (a device, a module (a part), and the like), and it does not matter whether or not all the components are in the same housing. Therefore, a plurality of devices housed in separate housings and connected via a network, and a single device with a plurality of modules housed in one housing are both systems.

Furthermore, the effects described in this specification are merely examples and are not limited, and other effects may be present.

Note that the present technology can have the following configurations.

(1)

A communication device including:

a control unit configured to perform control of,

in performing joint reception with a first communication device on a reception signal from one or more second communication devices,

generating first information indicating likelihood information of the reception signal for each of the one or more second communication devices,

generating second information regarding an information amount of the first information that can be stored in a storage unit configured to temporarily store the likelihood information, and

transmitting the first information and the second information to the first communication device.

(2)

The communication device according to (1) above, in which

the control unit performs control of
generating third information including: a number of a codeword targeted by the likelihood information indicated by the first information; and a quantum resolution of the likelihood information indicated by the first information, and
transmitting the third information to the first communication device.

(3)

The communication device according to (2) above, in which

the control unit performs control of
generating fourth information indicating a normalization coefficient in the first information, in which the likelihood information indicated by the first information is normalized likelihood information, and
transmitting the fourth information to the first communication device.

(4)

The communication device according to any one of (1) to (3) above, in which

the control unit executes control of,
in response to an execution request for joint reception notified from the first communication device, generating fifth information including: information indicating whether or not the joint reception is possible; information indicating the one or more second communication devices in executing the joint reception; information indicating a request scheme related to a calculation scheme of a log-likelihood ratio in the first communication device; and information indicating a frequency resource to be allocated to the one or more second communication devices, and
transmitting the fifth information to the first communication device.

(5)

The communication device according to any one of (1) to (4) above, in which

the control unit performs control of,
after the joint reception, generating sixth information including: information indicating, to the first communication device, a notification request for likelihood information for the reception signal from any of the one or more second communication devices; information indicating a range of the likelihood information to be requested for each of the one or more second communication devices; and information indicating a requested value of a resolution of the likelihood information, and
transmitting the sixth information to the first communication device.

(6)

The communication device according to any one of (1) to (5) above, in which

the control unit performs control of
generating seventh information including: information indicating link quality with the first communication device that performs the joint reception; information indicating a number of the first communication devices in the joint reception; and information indicating a frequency resource to be used by the one or more second communication devices to be a target of the joint reception in the joint reception, and
transmitting the seventh information to the one or more second communication device.

(7)

The communication device according to any one of (1) to (6) above, in which

the control unit performs control of
generating eighth information including: information indicating whether or not the joint reception is possible; and information indicating a calculation algorithm for the likelihood information, and
transmitting the eighth information to the first communication device and the one or more second communication devices.

(8)

The communication device according to any one of (1) to (7) above, further including:

a communication unit configured to transmit information by wireless communication.

(9)

The communication device according to any one of (1) to (8) above, in which

the communication device and the first communication device are access points, and

the one or more second communication device are communication terminals.

(10)

A communication device including:

a control unit configured to perform control of,

in performing joint reception with a first communication device on a reception signal from one or more second communication devices,

generating ninth information including: information indicating a request for the joint reception to the first communication device; information indicating a notification request for an information amount of first information that can be stored in a storage unit of the first communication device in the joint reception; and information indicating a request scheme related to a calculation scheme of a log-likelihood ratio in the first communication device, and transmitting the ninth information to the first communication device.

(11)

The communication device according to (10) above, in which

the control unit performs control of
generating tenth information including: information indicating whether or not the joint reception is possible; and information indicating a calculation algorithm for likelihood information, and
transmitting the tenth information to the first communication device and the one or more second communication devices.

(12)

The communication device according to (10) or (11) above, in which

the control unit performs control of generating eleventh information including:
information indicating link quality with the first communication device that performs the joint reception; information indicating a number of the first communication devices in the joint reception; and information indicating a frequency resource to be used by the one or more second communication devices to be a target of the joint reception in the joint reception, and
transmitting the eleventh information to the first communication device.

(13)

The communication device according to any one of (10) to (12) above, further including:

a communication unit configured to transmit information by wireless communication.

(14)

The communication device according to any one of (10) to (13) above, in which

the communication device and the first communication device are access points, and

the one or more second communication device are communication terminals.

(15)

A communication device that is a second communication device, the communication device including:

a control unit configured to perform control of,

in transmitting a transmission signal to, as a destination, a plurality of first communication devices that operates jointly with each other,

generating twelfth information indicating that joint reception is requested to the first communication devices, and

transmitting the twelfth information to the first communication devices.

(16)

The communication device according to (15) above, in which

the control unit performs control of
generating thirteenth information including: information indicating a number of first communication devices to be a destination and indicating the first communication devices; and information indicating a frequency resource to be used for each of the first communication devices to be a destination, and
transmitting the thirteenth information to the first communication devices.

(17)

The communication device according to (15) or (16) above, in which

the control unit performs control of
individually allocating codeword information to a frequency resource to be used for the plurality of first communication devices that operates jointly with each other, and
transmitting the codeword information allocated to the frequency resource.

(18)

The communication device according to any one of (15) to (17) above, in which

the control unit executes control of
generating fourteenth information indicating whether or not transmission signals can be simultaneously transmitted to the plurality of first communication devices capable of executing the joint reception, and
transmitting the fourteenth information to the first communication devices.

(19)

The communication device according to any one of (15) to (18) above, further including:

a communication unit configured to transmit information by wireless communication.

(20)

The communication device according to any one of (15) to (19) above, in which

the first communication devices are access points, and

the second communication device is a communication terminal.

### REFERENCE SIGNS LIST

10 Communication device
100 Control unit
101 Communication unit
102 Power supply unit
110 Wireless control unit
111 Data processing unit
112 Modulation/demodulation unit
113 Signal processing unit
114 Channel estimation unit
115, 115-1 to 115-N Wireless interface unit
116, 116-1 to 116-N Amplifier unit
117, 117-1 to 117-N Antenna unit
121, 122 Storage unit

1. A communication device comprising:
a control unit configured to perform control of,
in performing joint reception with a first communication device on a reception signal from one or more second communication devices,
generating first information indicating likelihood information of the reception signal for each of the one or more second communication devices,
generating second information regarding an information amount of the first information that can be stored in a storage unit configured to temporarily store the likelihood information, and
transmitting the first information and the second information to the first communication device.

2. The communication device according to claim 1, wherein
the control unit performs control of
generating third information including: a number of a codeword targeted by the likelihood information indicated by the first information; and a quantum resolution of the likelihood information indicated by the first information, and
transmitting the third information to the first communication device.

3. The communication device according to claim 2, wherein
the control unit performs control of
generating fourth information indicating a normalization coefficient in the first information, wherein the likelihood information indicated by the first information is normalized likelihood information, and
transmitting the fourth information to the first communication device.

4. The communication device according to claim 1, wherein
the control unit executes control of,
in response to an execution request for joint reception notified from the first communication device, generating fifth information including: information indicating whether or not the joint reception is possible; information indicating the one or more second communication devices in executing the joint reception; information indicating a request scheme related to a calculation scheme of a log-likelihood ratio in the first communication device; and information indicating a frequency resource to be allocated to the one or more second communication devices, and
transmitting the fifth information to the first communication device.

5. The communication device according to claim 1, wherein
the control unit performs control of,
after the joint reception, generating sixth information including: information indicating, to the first communication device, a notification request for likelihood information for the reception signal from any of the one or more second communication devices; information indicating a range of the likelihood information to be requested for each of the one or more second communication devices; and information indicating a requested value of a resolution of the likelihood information, and
transmitting the sixth information to the first communication device.

6. The communication device according to claim 1, wherein
the control unit performs control of
generating seventh information including: information indicating link quality with the first communication device that performs the joint reception; information indicating a number of the first communication devices in the joint reception; and information indicating a frequency resource to be used by the one or more second communication devices to be a target of the joint reception in the joint reception, and
transmitting the seventh information to the one or more second communication devices.

7. The communication device according to claim 1, wherein
the control unit performs control of
generating eighth information including: information indicating whether or not the joint reception is possible; and information indicating a calculation algorithm for the likelihood information, and
transmitting the eighth information to the first communication device and the one or more second communication devices.

8. The communication device according to claim 1, further comprising:
a communication unit configured to transmit information by wireless communication.

9. The communication device according to claim 1, wherein
the communication device and the first communication device are access points, and
the one or more second communication device are communication terminals.

10. A communication device comprising:
a control unit configured to perform control of,
in performing joint reception with a first communication device on a reception signal from one or more second communication devices,
generating ninth information including: information indicating a request for the joint reception to the first communication device; information indicating a notification request for an information amount of first information that can be stored in a storage unit of the first communication device in the joint reception; and information indicating a request scheme related to a calculation scheme of a log-likelihood ratio in the first communication device, and
transmitting the ninth information to the first communication device.

11. The communication device according to claim 10, wherein
the control unit performs control of
generating tenth information including: information indicating whether or not the joint reception is possible; and information indicating a calculation algorithm for likelihood information, and
transmitting the tenth information to the first communication device and the one or more second communication devices.

12. The communication device according to claim 10, wherein
the control unit performs control of
generating eleventh information including:
information indicating link quality with the first communication device that performs the joint reception; information indicating a number of the first communication devices in the joint reception; and information indicating a frequency resource to be used by the one or more second communication devices to be a target of the joint reception in the joint reception, and
transmitting the eleventh information to the first communication device.

13. The communication device according to claim 10, further comprising:
a communication unit configured to transmit information by wireless communication.

14. The communication device according to claim 10, wherein
the communication device and the first communication device are access points, and
the one or more second communication devices are communication terminals.

15. A communication device that is a second communication device, the communication device comprising:
a control unit configured to perform control of,
in transmitting a transmission signal to, as a destination, a plurality of first communication devices that operates jointly with each other,
generating twelfth information indicating that joint reception is requested to the first communication devices, and
transmitting the twelfth information to the first communication devices.

16. The communication device according to claim 15, wherein
the control unit performs control of
generating thirteenth information including:
information indicating a number of the first communication devices to be a destination and indicating the first communication devices; and information indicating a frequency resource to be used for each of the first communication devices as a destination, and
transmitting the thirteenth information to the first communication devices.

17. The communication device according to claim 15, wherein
the control unit performs control of
individually allocating codeword information to a frequency resource to be used for the plurality of first communication devices that operates jointly with each other, and
transmitting the codeword information allocated to the frequency resource.

18. The communication device according to claim 15, wherein
the control unit executes control of
generating fourteenth information indicating whether or not transmission signals can be simultaneously transmitted to the plurality of first communication devices capable of executing the joint reception, and
transmitting the fourteenth information to the first communication devices.

19. The communication device according to claim 15, further comprising:
a communication unit configured to transmit information by wireless communication.

20. The communication device according to claim 15, wherein
the first communication devices are access points, and
the second communication device is a communication terminal.
